(19) United States
(12) Patent Application Publication
(10) Pub. No.: US 2024/0224198 A1
(43) Pub. Date: Jul. 4, 2024

(54) SENSING HEADROOM REPORTS IN WIRELESS NETWORKS

(71) Applicant: QUALCOMM Incorporated, San Diego, CA (US)

(72) Inventors: Alexandros MANOLAKOS, Escondido, CA (US); Weimin DUAN, San Diego, CA (US); Xiaoxin ZHANG, Sunnyvale, CA (US)

(21) Appl. No.: 18/546,383

(22) PCT Filed: Jan. 27, 2022
(86) PCT No.: PCT/US2022/014009

§ 371 Date: Aug. 14, 2023

(30) Foreign Application Priority Data
Mar. 18, 2021 (GR) 20210100174

(51) Int. Cl. H04W 52/36; H04W 52/24; H04W 72/232; H04W 72/25

(52) U.S. Cl. CPC H04W 52/365; H04W 52/243; H04W 52/367; H04W 72/232; H04W 72/25

(57) ABSTRACT

Implementations of a sensing headroom report (HR), generating the sensing HR, and adjusting transmit powers and other parameters are described. A device transmits a radar wireless signal at a first transmit power from one or more transmit chains. The device also senses the radar wireless signal. The device generates a sensing HR based on sensing the radar wireless signal. The sensing HR may include one or more indications of metrics associated with a received power, such as a transmit power headroom, a sensing headroom, or a combination of a self-interference power, noise, and received power. The device provides the sensing HR to another device in the wireless network (such as via a base station and/or core network to a radar server), and another device may determine a transmit power or other device parameters to be used for sensing.

### CROSS-REFERENCE TO RELATED APPLICATIONS

This application claims priority to and the benefit of Greek Patent Application No. 20210100174, entitled “SENSING HEADROOM REPORTS IN WIRELESS NETWORKS,” filed Mar. 18, 2021, which is assigned to the assignee hereof and which is expressly incorporated herein by reference in its entirety.

### BACKGROUND

### Field

Subject matter disclosed herein relates to determining a transmit power for object or motion sensing in a wireless network and more particularly to generating sensing headroom reports for determining the transmit power for sensing.

### Information:

A user equipment (UE), such as a cellular telephone, or other devices in a wireless network may use radio frequency (RF) signals to sense objects or an object's motion in the device's environment. Determining whether objects exist or are moving in a device's environment may be useful or essential to a number of applications including locationing, environment mapping, depth ranging, and navigation. The RF signals that may be used may be defined for various wireless systems, such as a cellular network implemented according to 4G (also referred to as Fourth Generation) Long Term Evolution (LTE) radio access or 5G (also referred to as Fifth Generation) “New Radio” (NR) or a wireless network implemented according to the Institute of Electrical and Electronics Engineers (IEEE) 802.11 set of standards. A device includes at least two co-located antennas, with one antenna to transmit RF signals on a wireless channel and the other antenna to receive reflections of the RF signals on the wireless channel concurrently. The device senses the reflections of the transmitted signal at the receive antenna, with a round trip time (RTT) of the reflections being associated with a depth of an object in the device's environment (such as based on RAdio Detection And Ranging (RADAR) technologies). The device transmits the RF signals for sensing at a transmit power. Improvements in sensing and adjusting the transmit power for sensing are desirable.

### SUMMARY

In one implementation, a method of generating a sensing headroom report (HR) in a wireless network may be performed by a base station or a user equipment (UE). The sensing HR may be used by another component in the wireless network to determine the transmit power to be used by the device for sensing. The device transmits a radio detection and ranging (radar) wireless signal on a wireless medium at a first transmit power. The device also senses the radar wireless signal directly from at least one transmit chain of the first device. The device generates a sensing HR based on a received power during the sensing of the radar wireless signal. The sensing HR includes one or more indications of metrics associated with the received power, such as a transmit power headroom, a sensing headroom, or a combination of a self-interference power, noise power, and received power. The device provides the sensing HR to another device in the wireless network (such as via a base station and/or core network to a radar server in a cellular network), and the other device may determine a transmit power to be used for sensing by the device based on the metrics.

In one implementation, a method of generating a sensing HR by a first device in a wireless network includes: transmitting a radar wireless signal on a wireless medium at a first transmit power from one or more transmit chains of the first device; sensing the radar wireless signal; generating a sensing HR based on sensing the radar wireless signal; and providing the sensing HR to a network entity in the wireless network.

In one implementation, a device in a wireless network configured for generating a sensing HR includes at least one transceiver, at least one memory, and at least one processor coupled to the at least one transceiver and the at least one memory. The at least one processor is configured to cause the device to: transmit, via the at least one transceiver, a radar wireless signal on a wireless medium at a first transmit power from one or more transmit chains; sense, via the at least one transceiver, the radar wireless signal; generate, via the at least one processor, the sensing HR based on sensing the radar wireless signal; and provide, via the at least one transceiver, a sensing HR to a network entity in the wireless network.

In one implementation, a non-transitory computer-readable-medium stores instructions that, when executed by at least one processor of a device in a wireless network configured for generating a sensing HR, causes the device to: transmit, via at least one transceiver, a radar wireless signal on a wireless medium at a first transmit power from one or more transmit chains; sense, via the at least one transceiver, the radar wireless signal; generate, via the at least one processor, the sensing HR based on sensing the radar wireless signal; and provide, via the at least one transceiver, a sensing HR to a network entity in the wireless network.

In one implementation, a device for generating a sensing HR in a wireless network includes: means for transmitting a radar wireless signal on a wireless medium at a first transmit power from one or more transmit chains; means for sensing the radar wireless signal; means for generating a sensing HR based on sensing the radar wireless signal; and means for providing the sensing HR to a network entity in the wireless network.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary wireless communications system, according to various aspects of the disclosure.

FIG. 2 illustrates a block diagram of a design of base station and user equipment (UE), which may be one of the base stations and one of the UEs in FIG. 1.

FIG. 3 illustrates a UE capable of supporting motion detection services in a wireless network.

FIG. 4 illustrates a base station capable of supporting motion detection services in a wireless network.

FIG. 5 is a diagram illustrating transmission and sensing of reflections of a radar signal by a device for a monostatic radar solution.

FIG. 6 shows a flowchart for an exemplary method 600 for generating a sensing headroom report (HR) in a wireless network.

FIG. 7 shows a flowchart for an example method 700 of additional operations that may be performed in generating a sensing HR in a wireless network.

FIG. 8 shows a flowchart for an example method 800 for determining a final transmit power for transmitting a radar wireless signal.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IOT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB), etc. In addition, in some systems a base station may provide purely edge node signaling functions while in other systems it may provide additional control and/or network management functions. A communication link through which UEs can send signals to a base station is called an uplink (UL) channel or reverse link channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring.

Radar solutions for ranging or motion detection may be implemented by a device in a wireless network, such as a cellular network or a wireless local area network (WLAN). Solutions may be defined in the Third Generation Partnership Project (3GPP) set of standards for LTE (4G) and New Radio (NR) for Fifth Generation (5G). Solutions may also be defined in the Institute of Electrical and Electronics Engineers (IEEE) 802.11 set of standards for WLAN. Also or alternatively, a device may be configured to perform radar. A monostatic radar system includes one device both transmitting RF signals for radar (referred to as radar signals) and receiving the reflections of the radar signals. A monostatic radar system may be for identifying a motion state of the transmitting/receiving device or for identifying an object in the transmitting/receiving device's environment. For a monostatic radar system, a device (e.g., a base station (such as an AP or a gNB) or a UE (such as a smartphone)) may be configured to transmit radar signals and sense reflections of the radar signals to determine a RTT of the radar signal and a distance of an object reflecting the radar signals. The device's wireless transceiver is configured to transmit predefined radar signals for sensing (e.g., specific reference signal (RS) resources, RF signals at specific times, or RF signals at a specific frequency), and the device's wireless transceiver is configured to sense the reflections of the predefined radar signals (e.g., sensing the specific RS resources, the RF signals during specific time windows, or the RF signals at the specific frequency).

The transmit power of the radar signals affects the quality of radar solutions. For example, if the transmit power is too low, noise and other interference may prevent a device from successfully sensing a reflection of the radar signals. If the transmit power of the radar signals is too high, the received signals during sensing may reach a power level saturation point that prevents the device from successfully sensing the reflections of the radar signals. A device may be configured to adjust the transmit power for wireless communications, which may be defined by the 3GPP set of standards and the IEEE 802.11 set of standards. For example, a transmit power may be based on a RS strength indicator (RSSI) provided by a receiving device. However, the transmit power settings for wireless communications may not be suitable for sensing in a radar solution. For example, the device senses, at a receive chain, the radar signal directly from at least one transmit chain of the device. The radar signal sensed directly from at least one transmit chain may be leakage associated with transmitting at one or more ports or antennas of the device. The sensed radar signal directly from the at least one transmit chain may be interference to sensing the reflections of the radar signal (which may be referred to as a self-interference (SI)). As the transmit power increases, the SI power of the sensing radar signal increases. The sensitivity of the receive chain may be bounded by a maximum power level at which the receive chain becomes saturated and thus unable to successfully sense signals. With the one or more transmit chains co-located with the receive chain in the same device, a transmit power used for wireless communication with another device may be high enough to cause saturation at the receive chain if used for transmitting radar signals. The transmit power of radar signals may be specified by a different device of the wireless network. For example, a wireless network (e.g., a cellular network) may employ a radar server to define the RF signals (e.g., the specific RS resources, time windows, or frequencies) to be used for a radar solution. The radar server may also define the transmit power of the RF signals for the radar solution. The radar server may be part of or accessible from a serving network or a home network or may simply be accessible over the Internet or over a local Intranet.

Enhancements to measuring power metrics affecting sensing and reporting the power metrics to a device determining the transmit power for sensing are desirable. As noted above, the transmit power of the radar signals affects sensing, and a different device (e.g., a radar server) may determine the transmit power. One or more power metrics measured by the sensing device may be beneficial to the radar server in determining the transmit power to be used for radar.

Accordingly, as described herein, enhancements to determining power metrics and reporting the power metrics to a radar server is described. In one implementation, a device in a wireless network may transmit a radar wireless signal on a wireless medium at a first wireless power from one or more transmit chains of the device. The device may be a base station (e.g., a gNodeB (gNB)) or a UE transmitting radar signals determined by the radar server. The device may also sense the radar wireless signal on the wireless medium. The device may also generate a sensing headroom report (HR) based on sensing the radar wireless signal. Sensing the wireless signal may include one or more of sensing the wireless signal directly from at least one of the one or more transmit chains, sensing a reflection of the wireless signal on the wireless medium, or sensing a noise one the wireless medium. The overall signal that is received has a total received power. The total received power may include a SI power of the wireless signal sensed directly from the at least one transmit chain, a first received power of the reflection of the wireless signal sensed on the wireless medium, and/or a noise power of the noise sensed on the wireless medium. A sensing HR may indicate a power headroom (PH) associated with sensing (with the PH indicating a difference between an actual power (e.g., a SI power or a transmit power) and a maximum power (e.g., a maximum SI power associated with the receive chain or a maximum transmit power associated with the one or more transmit chains). Also or alternatively, the sensing HR may indicate a combination of one or more of the SI power, the total received power (also referred to as a received power), or the noise power. The device may also provide the sensing HR to a network entity in the wireless network. If the device is a base station (e.g., a gNB), the network entity may be the radar server or another component of the core network communicably coupled to the radar server. If the device is a UE, the network entity may be a base station (e.g., a gNB) or a relay UE to provide the sensing HR to the base station or the radar server. The radar server of the wireless network may determine a transmit power to be used to transmit radar signals by the device for sensing. Additionally or alternatively, one or more of a base station, a location server, or another network component (such as a core network component) may determine the transmit power or perform other operations described herein as being performed by the radar server. Some examples herein may refer to transmitting on a transmit chain and receiving on a receive chain exclusively for clarity in describing aspects of the present disclosure. Transmitting on a transmit chain may refer to transmitting on one or multiple transmit chains. Also or alternatively, receiving on a receive chain may refer to receiving on one or multiple receive chains.

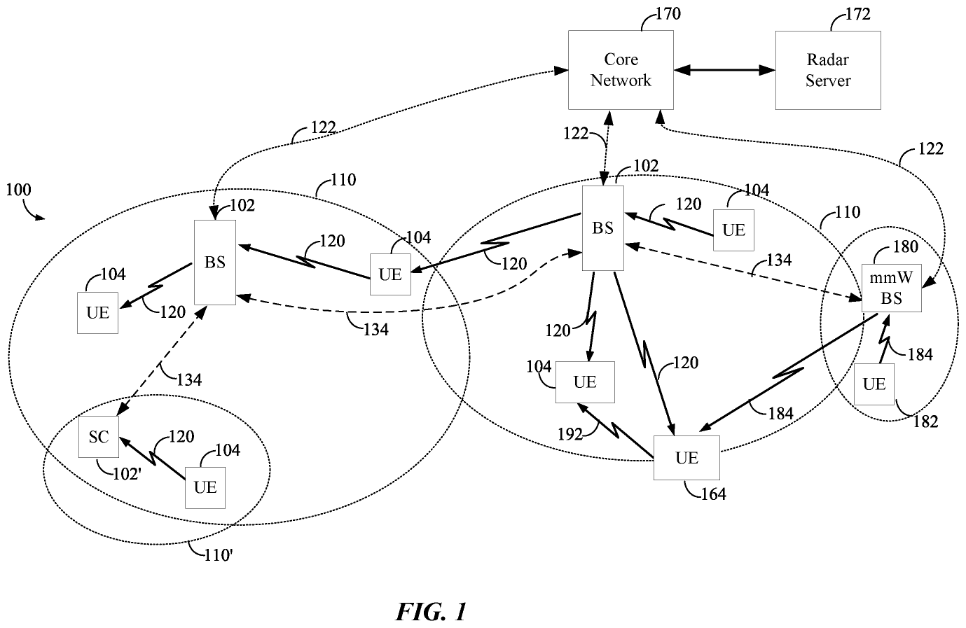

FIG. 1 illustrates an example wireless communications system 100. The wireless communications system 100 (which may also be referred to as a wireless wide area network (WWAN) or a wireless network) may include various base stations 102, sometimes referred to herein as gNBs 102 or other types of NBs, and various UEs 104. An example wireless network may include a cellular network. The base stations 102 may include macro cell base stations (high power cellular base stations) and/or small cell base stations (low power cellular base stations). In an aspect, the macro cell base station may include eNBs where the wireless communications system 100 corresponds to an LTE network, or gNBs where the wireless communications system 100 corresponds to a 5G network, or a combination of both, and the small cell base stations may include femtocells, picocells, microcells, etc.

The base stations 102 may collectively form a RAN and interface with a core network 170 (e.g., an evolved packet core (EPC) or next generation core (NGC)) through backhaul links 122, and through the core network 170 to one or more radar servers 172. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IOT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels. A secondary carrier is a carrier operating on a second frequency (e.g., FR2) that may be configured once the RRC connection is established between the UE 104 and the anchor carrier and that may be used to provide additional radio resources. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include one or more UEs, such as UE 190, that connects indirectly to one or more communication networks via one or more device-to-device (D2D) peer-to-peer (P2P) links. In the example of FIG. 1, UE 164 has a D2D P2P link 192 with one of the UEs 104 connected to one of the base stations 102. Link 192 may be used to indirectly obtain cellular connectivity or for D2D communications between UEs 104 and 164 without use of the base station 102. In some implementations, the link 192 is a sidelink (SL) between the UEs 104 and 164. In an example, the D2D P2P link 192 may be supported with any well-known D2D RAT, such as LTE Direct (LTE-D), WiFi Direct (WiFi-D), Bluetooth®, and so on.

The wireless communications system 100 may include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

The radar server 172 may include one or more radar servers that are to configure the wireless network to support ranging and object detection services based on radar technologies. The radar server 172 determines which signal resources are to be used for radar, and the radar server 172 indicates to the base station 102 (and the UEs via the base station) the signal resources to be used. As used herein, a signal resource may be any suitable frequency portion or time domain portion of the signal. The signals for radar may include any suitable reference signal (RS) or data signal. In some implementations, the radar server 172 determines one or more radar RS resources to include one or more of: a DL channel state information RS (DL-CSI-RS); a DL positioning reference signal (DL-PRS, which may be indicated by a location server coupled to the core network 170); a synchronization signal block (SSB, wherein each SSB is associated with a specific transmit beam of a base station transmitting the radar RS); a SL-SSB between UEs (wherein each SL-SSB is associated with a specific transmit beam of the UE transmitting the radar RS); a SL-CSI-RS; or a SL-PRS. While various RS resources or described, for a monostatic radar system, the signal may be any signal to be reflected by any object in the transmitting device's environment. The radar server 172 may also determine and indicate a transmit power to be used for radar by a base station 102 or a UE 104. Determining the transmit power may be based on one or more power metrics in one or more sensing HRs generated by a UE 104 or a base station 102.

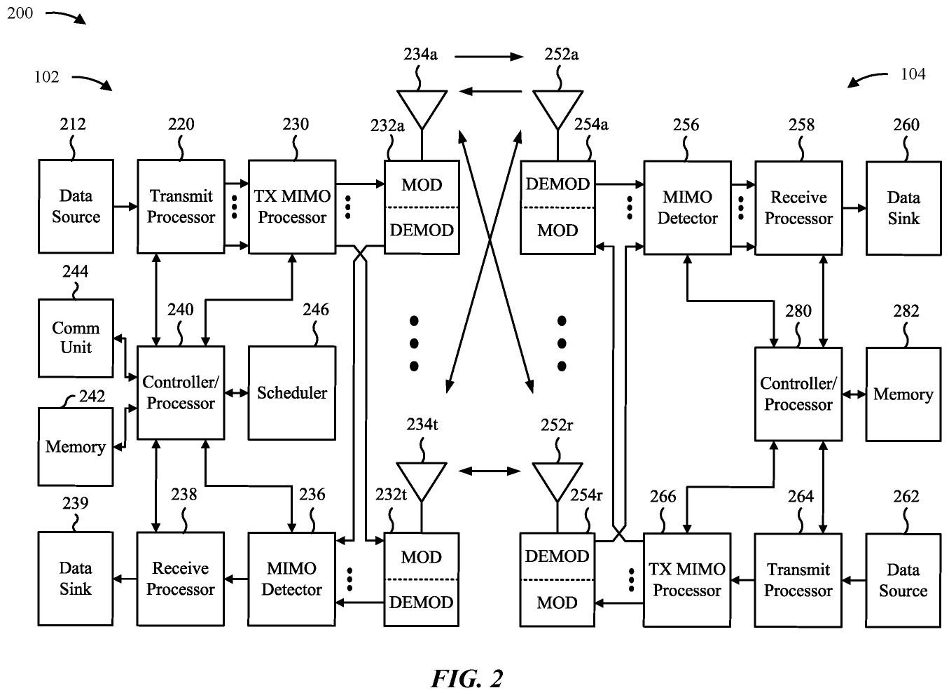

FIG. 2 shows a block diagram of a design 200 of a base station 102 and a UE 104, which may be one of the base stations and one of the UEs in FIG. 1. While design 200 depicts communications between a base station 102 and a UE 104, communications may be between two UEs 104 over a SL (such as a UE communicating with a relay UE), two base stations 102, or other devices of the wireless network 100. Referring to the design 200, base station 102 may be equipped with T antennas 234a through 234t, and UE 104 may be equipped with R antennas 252a through 252r, where in general T≥1 and R≥1. For a monostatic radar system, the number of antennas may be greater than 1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 104, antennas 252a through 252r may receive the downlink signals from base station 102 and/or other base stations and may provide received signals to demodulators (DEMODs) 254a through 254r, respectively. Each demodulator 254 may condition (e.g., filter, amplify, down convert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 104 may be included in a housing.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r, and transmitted to base station 102. At base station 102, the uplink signals from UE 104 and other UEs may be received by antennas 234, processed by demodulators 232, detected by a MIMO detector 236 if applicable, and further processed by a receive processor 238 to obtain decoded data and control information sent by UE 104. Receive processor 238 may provide the decoded data to a data sink 239 and the decoded control information to controller/processor 240. Base station 102 may include communication unit 244 and communicate to another device (such as core network component) via communication unit 244.

Controller/processor 240 of base station 102, controller/processor 280 of UE 104, and/or any other component(s) of FIG. 2 may perform one or more techniques associated with performing motion detection services, as described in more detail elsewhere herein. For example, controller/processor 240 of base station 102, controller/processor 280 of UE 104, and/or any other component(s) of FIG. 2 may perform or direct operations of, for example, the described processes depicted in the figures and/or other processes as described herein. Memories 242 and 282 may store data and program codes for base station 102 and UE 104, respectively. In some aspects, memory 242 and/or memory 282 may comprise a non-transitory computer-readable medium storing one or more instructions for wireless communication. For example, the one or more instructions, when executed by one or more processors of base station 102 and/or the UE 104 may perform or direct operations of the processes as described herein. A scheduler 246 may schedule UEs for data transmission on the downlink and/or uplink. In some implementations, a scheduler may be used by a UE 104 for data transmission on a sidelink.

As indicated above, FIG. 2 is provided as an example. Other examples may differ from what is described with regard to FIG. 2 (such as communications between two UEs or other types of devices of the wireless network or of a different type of wireless network).

In the frequency domain for an uplink, downlink, or sidelink transmission, the available bandwidth may be divided into uniformly spaced orthogonal subcarriers (also referred to as “tones” or “bins”). For example, for a normal length cyclic prefix (CP) using, for example, 15 kHz spacing, subcarriers may be grouped into a group of 12 subcarriers. A resource of one OFDM symbol length in the time domain and one subcarrier in the frequency domain is referred to as a resource element (RE). Each grouping of the 12 subcarriers and 14 OFDM symbols is termed a resource block (RB) and, in the example above, the number of subcarriers in a resource block may be written as N_{SC}^{RB}=12. For a given channel bandwidth, the number of available resource blocks on each channel, which is also called a transmission bandwidth configuration, is indicated as N_{RB}^{DL}. For example, for a 3 MHz channel bandwidth in the above example, the number of available resource blocks on each channel is given by N_{RB}^{DL}=15. Note that the frequency component of a resource block (e.g., the 12 subcarriers) is referred to as a physical resource block (PRB).

If specific resource elements are to be used for radar, a collection of resource elements that are used for radar may be referred to as a “radar resource.” If the resource elements are from one or more reference signals, the collection of resource elements may be referred to as a “radar RS resource.” The collection of resource elements can span multiple PRBs in the frequency domain and one or more symbol(s) within a slot or across slots in the time domain. A base station or UE may transmit radar resources at a transmit power for use in radar. For example, an indication of one or more radar resources and the transmit power to be used may be received at a communication unit 244 of base station 102 from a radar server 172. In some implementations, the base station 102 may configure itself to transmit the one or more radar resources over a downlink or over any suitable frequency, time window, etc. that may be indicated by the radar server. In some implementations, the base station 102 may indicate the one or more radar resources to one or more UEs 104, and a UE 104 may transmit the one or more radar resources over a sidelink or over any suitable frequency, time window, etc. that may be indicated by the radar server.

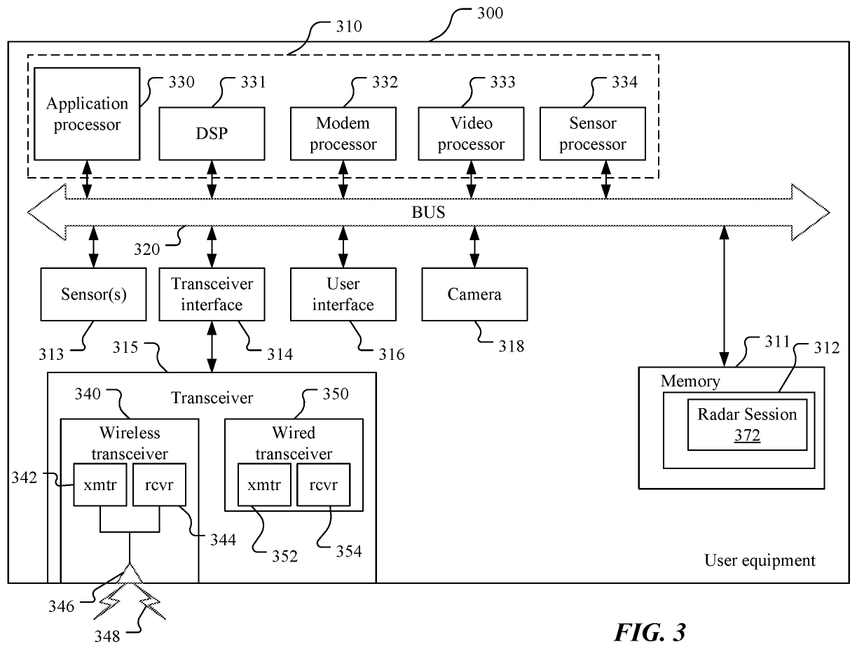

FIG. 3 illustrates a UE 300, which is an example of the UE 104, capable of supporting radar in a wireless network (such as a cellular network). For example, the UE 300 may be configured to transmit and/or receive radar wireless signals, sense reflections of the radar wireless signals, measure one or more power metrics, and report the one or more power metrics in a sensing HR to the radar server 172 (such as via a base station or a relay UE). The UE 300 includes a computing platform including at least one processor 310, memory 311 including software (SW) 312, one or more sensors 313, a transceiver interface 314 for a transceiver 315, a user interface 316, and a camera 318. The processor 310, the memory 311, the sensor(s) 313, the transceiver interface 314, the user interface 316, and the camera 318 may be communicatively coupled to each other by a bus 320 (which may be configured, e.g., for optical and/or electrical communication). One or more of the shown apparatus (e.g., the camera 318 and/or one or more of the sensor(s) 313, etc.) may be omitted from the UE 300 or the UE 300 may include additional apparatus not shown (e.g., a positioning system receiver (such as a global navigation satellite system (GNSS) or a global positioning system (GPS) receiver and processing components). The processor 310 may include one or more intelligent hardware devices, e.g., a central processing unit (CPU), a microcontroller, an application specific integrated circuit (ASIC), etc. The processor 310 may comprise multiple processors including an application processor 330, a Digital Signal Processor (DSP) 331, a modem processor 332, a video processor 333, and/or a sensor processor 334. One or more of the processors 330-334 may include multiple devices (e.g., multiple processors). For example, the sensor processor 334 may include, e.g., processors for radar, ultrasound, and/or lidar, etc. The modem processor 332 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 300 for connectivity. The memory 311 is a non-transitory storage medium that may include random access memory (RAM), flash memory, disc memory, and/or read-only memory (ROM), etc. The memory 311 stores the software 312, which may be processor-readable, processor-executable software code containing instructions that are configured to, when executed, cause the processor 310 to operate as a special purpose computer programmed to perform the various functions described herein. Alternatively, the software 312 may not be directly executable by the processor 310 but may be configured to cause the processor 310, e.g., when compiled and executed, to operate as a special purpose computer to perform the various functions described herein. The description may refer only to the processor 310 performing a function, but this includes other implementations such as where the processor 310 executes software and/or firmware. The description may refer to the processor 310 performing a function as shorthand for one or more of the processors 330-334 performing the function. The description may refer to the UE 300 performing a function as shorthand for one or more appropriate components of the UE 300 performing the function. The processor 310 may include a memory with stored instructions in addition to and/or instead of the memory 311. Functionality of the processor 310 is discussed more fully below.

The configuration of the UE 300 shown in FIG. 3 is an example and not limiting of the disclosure, including the claims, and other configurations may be used. For example, an example configuration of the UE includes one or more of the processors 330-334 of the processor 310, the memory 311, and the wireless transceiver 340. Other example configurations include one or more of the processors 330-334 of the processor 310, the memory 311, the wireless transceiver 340, and one or more of the sensor(s) 313, the user interface 316, the camera 318, and/or the wired transceiver 350.

The UE 300 may comprise the modem processor 332 that may be capable of performing baseband processing of signals received and down-converted by the transceiver 315. The modem processor 332 may perform baseband processing of signals to be upconverted for transmission by the transceiver 315. Also or alternatively, baseband processing may be performed by the processor 330 and/or the DSP 331. Other configurations, however, may be used to perform baseband processing.

The UE 300 may include the sensor(s) 313 that may include, for example, one or more of various types of sensors such as one or more inertial sensors, one or more barometric pressure sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 300 in three dimensions) and/or one or more gyroscopes capable of detecting motion including rotation of the UE 300. The sensor(s) 313 may include one or more magnetometers to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 313 may generate analog and/or digital signals indications of which may be stored in the memory 311 and processed by the DSP 331 and/or the processor 330 in support of one or more applications such as, for example, applications directed to positioning and/or navigation operations.

The sensor(s) 313 may be used in relative location measurements, relative location determination, motion determination, etc. Information detected by the sensor(s) 313 may be used for motion detection, relative displacement, dead reckoning, sensor-based location determination, and/or sensor-assisted location determination. The IMU may be configured to provide measurements about a direction of motion and/or a speed of motion of the UE 300, which may be used in relative location determination. For example, one or more accelerometers and/or one or more gyroscopes of the IMU may detect, respectively, a linear acceleration and a speed of rotation of the UE 300. The linear acceleration and speed of rotation measurements of the UE 300 may be integrated over time to determine an instantaneous direction of motion as well as a displacement of the UE 300. The instantaneous direction of motion and the displacement may be integrated to track a location of the UE 300. For example, a reference location of the UE 300 may be determined for a moment in time, and measurements from the accelerometer(s) and gyroscope(s) taken after this moment in time may be used in dead reckoning to determine present location of the UE 300 based on movement (direction and distance) of the UE 300 relative to the reference location.

The magnetometer(s) may determine magnetic field strengths in different directions which may be used to determine orientation of the UE 300. For example, the orientation may be used to provide a digital compass for the UE 300. The magnetometer may be a two-dimensional magnetometer configured to detect and provide indications of magnetic field strength in two orthogonal dimensions. Alternatively, the magnetometer may be a three-dimensional magnetometer configured to detect and provide indications of magnetic field strength in three orthogonal dimensions. The magnetometer may provide means for sensing a magnetic field and providing indications of the magnetic field, e.g., to the processor 310.

The barometric pressure sensors(s) may determine air pressure, which may be used to determine the elevation or current floor level in a building of the UE 300. For example, a differential pressure reading may be used to detect when the UE 300 has changed floor levels as well as the number of floors that have changed. The barometric pressure sensors(s) may provide means for sensing air pressure and providing indications of the air pressure, e.g., to the processor 310.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels and/or one or more sidelink channels) and/or receiving (e.g., on one or more downlink channels and/or one or more sidelink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with a base station and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHZ frequencies. The wired transceiver 350 may include a transmitter 352 and a receiver 354 configured for wired communication. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication. The transceiver 315 may be communicatively coupled to the transceiver interface 314, e.g., by optical and/or electrical connection. The transceiver interface 314 may be at least partially integrated with the transceiver 315. In some implementations, the transceiver 315 does not include a wired transceiver 350.

The antennas 346 may include an antenna array, which may be capable of receive beamforming or transmit beamforming, e.g., by increasing the gain setting and/or adjust the phase setting of an array of antennas in a particular direction to amplify (e.g., to increase the gain level of) the RF signals received from or transmitted towards that direction. The antennas 346 may further include a plurality of antenna panels, wherein each antenna panel is capable of beamforming. The antennas 346 are capable of adaptation, e.g., selection of one or more antennas for controlling receiving transmitted beams from or transmitting beams towards a base station or another UE. A reduced number of beams or a single beam, for example, may be selected for reception of a wide angle beam, e.g., to reduce power consumption, while an increased number of antennas in an antenna array may be selected when the transmit beam is relatively narrow. Conversely, the antennas 346 may be configured to transmit a wide angle beam or a relatively narrow beam.

The user interface 316 may comprise one or more of several devices such as, for example, a speaker, microphone, display device, vibration device, keyboard, touch screen, etc. The user interface 316 may include more than one of any of these devices. The user interface 316 may be configured to enable a user to interact with one or more applications hosted by the UE 300. For example, the user interface 316 may store indications of analog and/or digital signals in the memory 311 to be processed by DSP 331 and/or the processor 330 in response to action from a user. Similarly, applications hosted on the UE 300 may store indications of analog and/or digital signals in the memory 311 to present an output signal to a user. The user interface 316 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 316 may comprise one or more touch sensors responsive to touching and/or pressure, e.g., on a keyboard and/or touch screen of the user interface 316.

The UE 300 may include the camera 318 for capturing still or moving imagery. The camera 318 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 330 and/or the DSP 331. Also or alternatively, the video processor 333 may perform conditioning, encoding, compression, and/or manipulation of signals representing captured images. The video processor 333 may decode/decompress stored image data for presentation on a display device (not shown), e.g., of the user interface 316.

The memory 311 may store software 312 that contains executable program code or software instructions that when executed by the processor 310 may cause the processor 310 to operate as a special purpose computer programmed to perform the functions disclosed herein. As illustrated, the memory 311 may include one or more components or modules that may be implemented by the processor 310 to perform the disclosed functions. While the components or modules are illustrated as software 312 in memory 311 that is executable by the processor 310, it should be understood that the components or modules may be stored in another computer readable medium or may be dedicated hardware either in the processor 310 or off the processor. A number of software modules and data tables may reside in the memory 311 and be utilized by the processor 310 in order to manage both communications and the functionality described herein. It should be appreciated that the organization of the contents of the memory 311 as shown is merely exemplary, and as such the functionality of the modules and/or data structures may be combined, separated, and/or be structured in different ways depending upon the implementation.

The memory 311, for example, may include a radar session module 372 that when implemented by the one or more processors 310 configures the one or more processors 310 to engage in a monostatic radar session, e.g., transmitting radar signals and sensing reflections of the radar signals, as described herein. For example, the one or more processors 310 may be configured to engage in a radar session by performing one or more of transmitting a radar wireless signal on a wireless medium at a first transmit power, sense the radar wireless signal on the wireless medium directly from its own transmit chain, generate a sensing HR based on a received power during the sensing of the radar wireless signal, or transmit the sensing HR to a network entity in the wireless network. While the radar session module 372 is depicted as being software included in memory 311, the radar session module 372 may be a hardware module, a software module, or a combination of hardware and software. For example, the module may include one or more application specific integrated circuits (ASICs), executable code, or a combination of both.

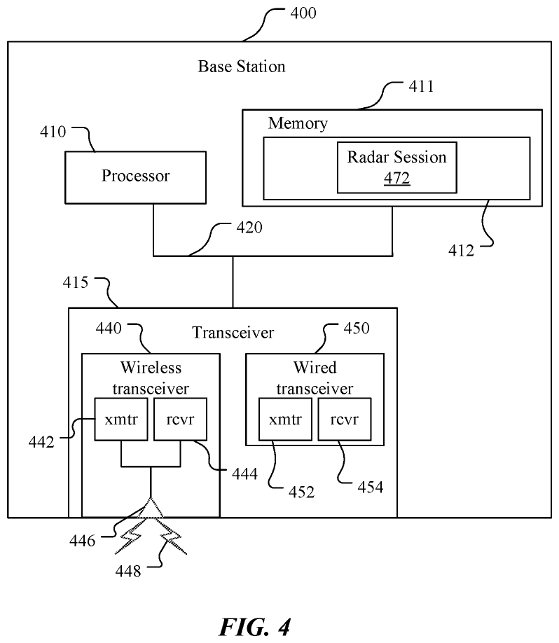

FIG. 4 illustrates a base station 400, which is an example of the base station 102, capable of supporting radar services in a wireless network (such as wireless network 100). The base station 400 includes a computing platform including at least one processor 410, a memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus may be omitted from the base station 400, or the base station 400 may include one or more apparatus not shown. The processor 410 may include one or more intelligent hardware devices, e.g., a central processing unit (CPU), a microcontroller, an application specific integrated circuit (ASIC), etc. The processor 410 may comprise multiple processors (e.g., including one or more of an application processor, a DSP, a modem processor, a video processor, and/or a sensor processor, similar to that shown in FIG. 3). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to operate as a special purpose computer programmed to perform the various functions described herein. Alternatively, the software 412 may not be directly executable by the processor 410 but may be configured to cause the processor 410, e.g., when compiled and executed, to operate as a special purpose computer to perform the various functions described herein. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the base station 400 performing a function as shorthand for one or more appropriate components of the base station 400 performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting and/or receiving (e.g., on one or more uplink channels and/or one or more downlink channels) wireless signals 448 and transducing signals from the wireless signals 448 to wired (e.g., electrical and/or optical) signals and from wired (e.g., electrical and/or optical) signals to the wireless signals 448. The antenna 446 is one or more antenna arrays capable of beam forming and transmitting and receiving beams, including beams used in transmitting or receiving signals (including radar signals) to radar services. Also or alternatively, radar signals may be transmitted omnidirectionally. The transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 400, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., to send communications to, and receive communications from, the radar server 172. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the base station 400 shown in FIG. 4 is an example and not limiting of the disclosure, including the claims, and other configurations may be used. For example, the description herein discusses that the base station 400 is configured to perform or performs several functions, but one or more of these functions may be performed by the radar server 172 and/or the UE 300.

The memory 411 may store software 412 that contains executable program code or software instructions that when executed by the processor 410 may cause the processor 410 to operate as a special purpose computer programmed to perform the functions disclosed herein. As illustrated, the memory 411 may include one or more components or modules that may be implemented by the processor 410 to perform the disclosed functions. While the components or modules are illustrated as software 412 in memory 411 that is executable by the processor 410, it should be understood that the components or modules may be stored in another computer readable medium or may be dedicated hardware either in the processor 410 or off the processor. A number of software modules and data tables may reside in the memory 411 and be utilized by the processor 410 in order to manage both communications and the functionality described herein. It should be appreciated that the organization of the contents of the memory 411 as shown is merely exemplary, and as such the functionality of the modules and/or data structures may be combined, separated, and/or be structured in different ways depending upon the implementation.

The memory 411, for example, may include a radar session module 472 that when implemented by the processor 410 configures the processor 410 to engage in a monostatic radar session as described herein or a multistatic radar session. For example, the one or more processors 410 may configure the base station 400 to indicate the one or more radar resources (or other parameters of the radar wireless signal) to be used to one or more UEs 104 to transmit the resources, to transmit the radar wireless signal, to receive reflections of the radar wireless signal, to determine one or more power metrics based on the reflections, to generate a sensing HR including the one or more power metrics, to provide the sensing HR to the radar server 172 (such as via one or more core network components), to obtain a sensing HR from a UE 104 performing radar services, or to relay the obtained reports to the radar server 172. While the radar session module 472 is depicted as being software included in memory 411, the radar session module 472 may be a hardware module, a software module, or a combination of hardware and software. For example, the module may include one or more application specific integrated circuits (ASICs), executable code, or a combination of both.

A UE or a base station (e.g., a gNB) may perform radar services by transmitting a radar wireless signal, sense reflections of the radar wireless signal, and/or determine a depth or motion of an object based on the reflections. Standalone monostatic radar systems determine a phase offset between the transmitted radar signal and the received reflection of the radar signal. The phase offset (also referred to as a phase difference) is associated with a round trip time (RTT) of the radar signal and indicates a depth of an object from the transmitter and receiver. Multiple depths over time indicates a motion state of the object (such as a speed, velocity, or other suitable motion degree).

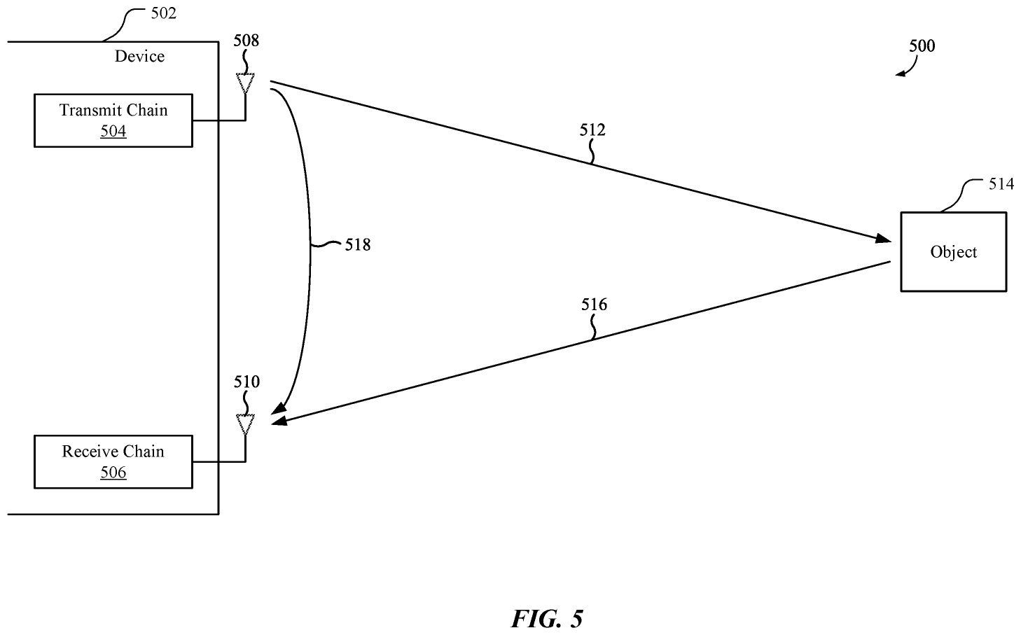

FIG. 5 is a diagram 500 illustrating transmission and sensing of reflections of a radar signal by a device 502 for a monostatic radar solution. The device 502 may be a UE (such as a UE 104 or 300), a base station (such as a base station 102 or 400, which may be a gNB), another suitable device of a cellular network, or another suitable device of a different wireless network (such as device in a WLAN). The device 502 includes transmit chain 504 (which may include one or multiple transmit chains) coupled to antenna 508 and receive chain 506 (which may include one or multiple receive chains) coupled to antenna 510. Each of antenna 508 and antenna 510 may be one or more antennas for wireless communication with another device. For example, the antenna 508 and antenna 510 may be included in one or more antenna arrays (such as the antennas 234 or the antennas 252). The antenna 508 and the antenna 510 are co-located on the device 502, and the antenna 508 is configured to transmit the radar signal 512 while the antenna 510 is configured to receive reflection 516 of the radar signal 512 (which is reflected by object 514).

A wireless transceiver of the device 502 includes the transmit chain 504 and the receive chain 506. For example, the transmit chain 504 may be included in the transmitter 342 of the wireless transceiver 340 of the UE 300, or the transmit chain 504 may be included in the transmitter 442 of the wireless transceiver 440 of the base station 400. FIG. 2 depicts a simplified version of a single transmit chain and a single receive chain for clarity, but any number of transmit chains and receive chains may exist in the device. A transmit chain 504 (which may include one or more transmit chains) may include a digital to analog converter (such as modulator 232) to convert a digital sequence to an analog signal and a front end to transmit the analog signal in a radar wireless signal 512 via the antenna 508. A receive chain 506 (which may include one or more receive chains) may include a front end to sense the reflection 516 via the antenna 510 and an analog to digital converter (such as a demodulator 254) to convert the received analog signal to a digital sequence. The timing of the transmitted digital sequence may be compared to the timing of the received digital sequence to determine a phase difference in determining a RTT. The RTT may be used to determine the distance of the object 514 from the device 502.

During sensing, the receive chain 506 may receive the radar signal directly from the transmit chain 504 (depicted as signal 518). For example, the antenna 508 may include leakage so that the co-located antenna 510 receives the radar signal directly from the antenna 508. While the signal 518 is depicted as being received over the wireless medium for clarity, the signal 518 may be received through other mediums (such as in the device itself or along a physical medium delivering the leakage (e.g., a device housing)). As such, receiving the signal 518 directly from at least one transmit chain may refer to receiving the signal on the wireless medium or via another suitable medium. The directly received radar signal 518 acts as interference to sensing the reflection 516 and may be referred to as self-interference (SI). Receiving the reflection 516 by the receive chain 506 may also be associated with a noise, which may include ambient noise or interference in the environment (including other wireless signals at the same or neighboring frequency as the radar signal). In this manner, the total signal received by the receive chain 506 includes the reflection 516, the signal 518, and the noise. The received power at the antenna 510 corresponds to the total signal. The received power may include a power of the received reflection 516, a SI power of the received signal 518, and a noise power. While FIG. 5 depicts leakage and transmission associated with one transmit chain, a radar signal may be transmitted on one or more transmit chains. In this manner, the radar signal received directly may be from at least one of the one or more transmit chains. In some instances, the reflection 516 and the direct radar signal 518 may originate from the same transmit chain. In some other instances, the reflection 516 and the direct radar signal 518 may originate from different transmit chains. As such, as used herein, transmitting at a transmit chain may refer to transmitting at one or more transmit chains, and receiving directly from the transmit chain may refer to receiving directly from at least one of the one or more transmit chains transmitting.

When the device 502 transmits signals to another device during wireless communications, SI may not be a concern since the device 502 is not receiving the transmitted signals. The device 502 may increase the transmit power to increase the receive signal strength (RSS) at the receiving device. The transmit power may be increased up to a maximum transmit power, which may be based on limitations in hardware or limitations imposed by one or more standards. Regarding radar, if the device 502 is transmitting a radar signal 512, increasing the transmit power increases the power of the signal 512 and the reflection 516, but increasing the transmit power also increases the power of the signal 518 (referred to as a SI power). The receive chain 506 may be able to sense a signal within a range of received power (such as less than a maximum received power). The receive chain 506 becomes saturated if the received power is greater than the range, and the receive chain 506 is unable to recover a digital sequence from the received signal. If the transmit power is too high, the SI power may cause the received power to be greater than the range. Also or alternatively, increasing the transmit power may increase the SI power more than the power of the reflection 516. If the SI power is too close to the power of the reflection, the receive chain 506 may be unable to discern the reflection 516 from the signal 518.

In some implementations, the device 502 may determine a transmit power to be used when sensing radar signals that is different than a transmit power for wireless communications, measure one or more power metrics associated with sensing radar signals, and report the one or more power metrics in a sensing HR (which may be provided to a radar server 172 or another device). The one or more power metrics may be used to determine a transmit power that improves sensing of radar signals, and determining the transmit power to be used for sensing radar signals is based on improving sensing for radar (which may differ from simply increasing the transmit power to improve reception at a different device).

A power headroom (PH) for wireless communications is defined in the 3GPP set of standards for 5G NR. A PH value defined in the 3GPP set of standards is an indication of the difference between the current transmit power and a maximum transmit power of a UE. The UE may report the PH information to a gNB in a PH report (PHR) media access control layer (MAC) control element (MAC CE) transmitted over a physical layer (PHY) uplink shared channel (PUSCH). The PH information includes a maximum transmit power value and a PH value for each serving cell of the UE configured for uplink. The gNB may use the PH values from the received PHRs to determine how to schedule transmissions to and from the UE. The IEEE 802.11 set of standards defines a station headroom value as a difference between a maximum transmit power and an actual transmit power of the station, and the station may report the station headroom value to the access point.

Referring back to the PH defined in the 3GPP set of standards for 5G NR, a UE transmitting at a transmit power less than the maximum transmit power has a positive PH value of the maximum transmit power minus the actual transmit power. A resulting PHR may be referred to as a positive report. In some instances, the maximum transmit power may be associated with a maximum transmit power to be used in the wireless network or otherwise indicated, but the UE may be able to transmit at a higher power than the maximum power. In this manner, the actual transmit power of the UE may be greater than the maximum transmit power, and the UE has a negative PH value of the maximum transmit power minus the actual transmit power. A resulting PHR may be referred to as a negative report.

A device, such as a UE or a base station, may be configured to generate a sensing HR. The sensing HR is a similar concept to a PHR, but the metrics to be measured and reported differ from the PH information included in the PHR. The sensing HR may be used in determining a transmit power, scheduling use of radar for a device, or otherwise managing the device to support radar.

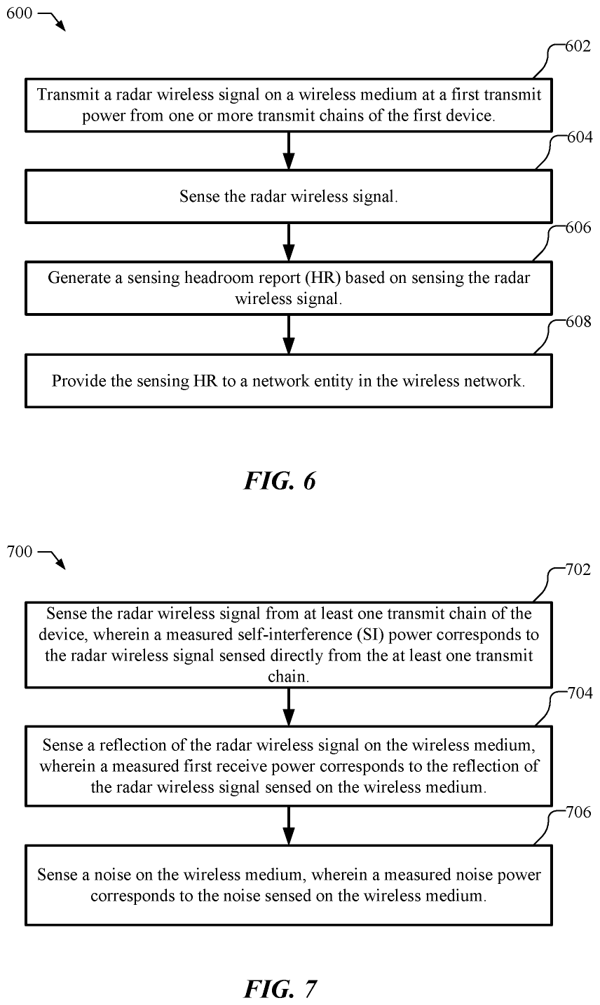

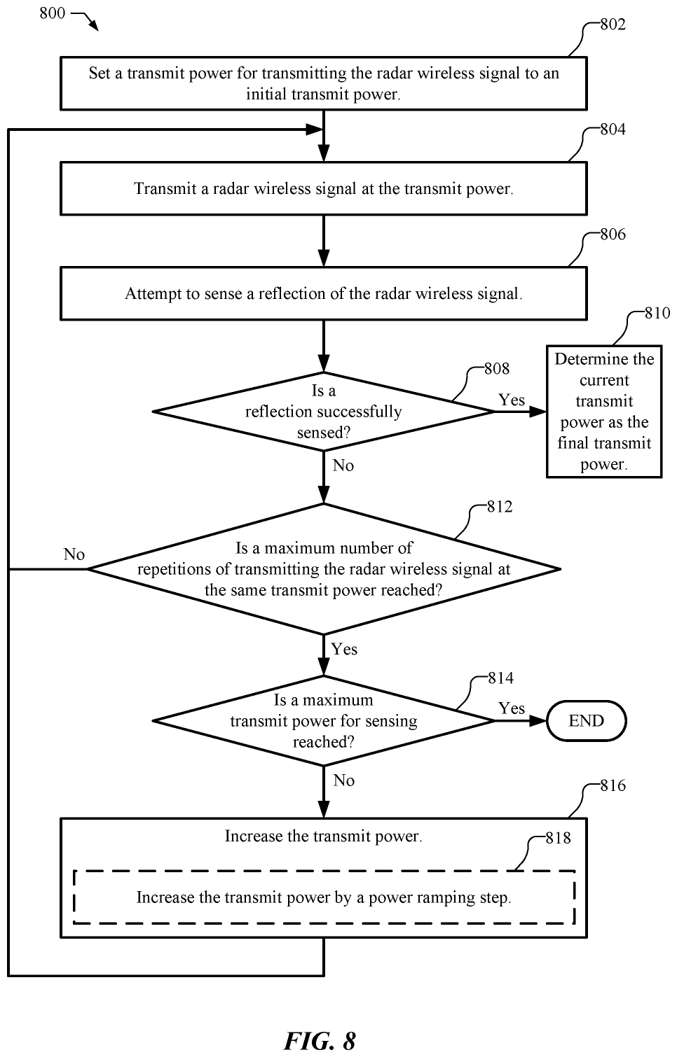

FIG. 6 shows a flowchart for an exemplary method 600 for generating a sensing HR in a wireless network. The exemplary method 600 may be performed by any suitable device 502 of a wireless network, such as base station 102 or 400 shown in FIGS. 1 and 4 or a UE 104 or 300 shown in FIGS. 1 and 3 in a wireless network (e.g., a cellular network), in a manner consistent with disclosed implementations. For example, a device that may perform one or more operations in method 600 (or any of the other described methods, such as method 700 in FIG. 7 or method 800 in FIG. 8) may include at least one transceiver (such as one or more wireless transceivers and/or one or more wired transceivers), at least one memory, and at least one processor coupled to the at least one transceiver and the at least one memory. Referring to the UE 300 as an example device, the at least one transceiver may include the transceiver 315 or the wireless transceiver 340, the at least one memory may include the memory 311, and the at least one processor may include the processor 310 or one or more of processors 330-334. Referring to the base station 400 as an example device, the at least one transceiver may include the transceiver 415 or the wireless transceiver 440, the at least one memory may include the memory 411, and the at least one processor may include the processor 410.

At block 602, the device 502 transmits a radar wireless signal on a wireless medium at a first transmit power from one or more transmit chains of the first device. Means for transmitting the radar wireless signal may include at least one transceiver (such as a wireless transceiver) of the device. For example, a wireless transceiver of the device 502 includes a transmit chain 504 to convert a digital sequence and generate an analog signal that is transmitted using antenna 508.

At block 604, the device 502 senses the radar wireless signal. Means for sensing the radar wireless signal may include the at least one transceiver (such as the wireless transceiver) of the device. Sensing the radar wireless signal may include one or more of sensing the wireless signal directly from at least one of the one or more transmit chains, sensing one or more reflections of the wireless signal on the wireless medium, or sensing a noise on the wireless medium (described below with reference to FIG. 7).

FIG. 7 shows a flowchart for an example method 700 for generating a sensing HR in a wireless network. The example method 700 may be an example implementation of block 604 in FIG. 6. The exemplary method 700 may be performed by any suitable device 502 of a wireless network, such as base station 102 or 400 shown in FIGS. 1 and 4 or a UE 104 or 300 shown in FIGS. 1 and 3 in a wireless network (e.g., a cellular network), in a manner consistent with disclosed implementations. While all blocks 702-706 are depicted as being performed by a device, the device may perform only a portion of the blocks 702-706 or multiple instances of one or more of blocks 702-706. In this manner, the overall signal sensed by the device may include one or more of the radar wireless signal sensed directly from at least one transmit chain of the device, the reflection of the radar wireless signal sensed on the wireless medium, or a noise on the wireless medium.

At block 702, the device 502 senses the radar wireless signal directly from at least one transmit chain of the device 502. A measured SI power corresponds to the radar wireless signal sensed directly from the at least one transmit chain. For example, the overall signal sensed by the device 502 includes a total receive power. The sensed overall signal may include the radar wireless signal sensed from the at least one transmit chain of the device 502, and the total receive power includes a SI power corresponding to the radar wireless signal sensed directly from the at least one transmit chain of the device 502. Means for sensing the radar wireless signal directly from the at least one transmit chain may include an at least one transceiver (such as a wireless transceiver) of the device. For example, the receive chain 506 may sense the radar wireless signal directly from the transmit chain 504 and/or another transmit chain of the device 502 transmitting the radar wireless signal. The antenna 508 (which may include one or more antennas) transmitting the radar wireless signal is associated with a transmission leakage, and the leaked signal may be received at antenna 510 (which may include one or more antennas) used for sensing. The wireless transceiver of the device 502 may include the receive chain 506 (which may include one or more receive chains) to sense the radar wireless signal directly from the transmit chain 504 (and/or another transmit chain) while listening for reflections of the radar wireless signal.

At block 704, the device 502 senses a reflection of the radar wireless signal on the wireless medium. A measured first receive power corresponds to the reflection of the radar wireless signal sensed on the wireless medium. For example, as noted above, the overall signal sensed by the device 502 includes a total receive power. The sensed overall signal may include the reflection of the radar wireless signal, and the total receive power includes the total receive power corresponding to the reflection of the radar wireless signal sensed on the wireless medium. Means for sensing the reflection of the radar wireless signal on the wireless medium may include an at least one transceiver (such as a wireless transceiver) of the device. For example, the receive chain 506 may sense the reflection of the radar wireless signal. An object in the device's environment may reflect the radar wireless signal transmitted by the device, and such reflection may be sensed by the device. The wireless transceiver of the device 502 may include the receive chain 506 (which may include one or more receive chains) to sense the reflection of the radar wireless signal.

At block 706, the device 502 senses a noise on the wireless medium. A measured noise power corresponds to the noise sensed on the wireless medium. For example, as noted above, the overall signal sensed by the device 502 includes a total receive power. The sensed overall signal may include noise on the wireless medium, and the total receive power includes the noise power corresponding to the noise sensed on the wireless medium. Means for sensing the noise on the wireless medium may include an at least one transceiver (such as a wireless transceiver) of the device. For example, the receive chain 506 may sense the noise. The noise may include signals or other energy on the wireless medium not corresponding to leakage or reflections of the transmission from the device. The wireless transceiver of the device 502 may include the receive chain 506 (which may include one or more receive chains) to sense the noise.

Referring back to FIG. 6, at block 606, the device 502 generates a sensing HR based on sensing the radar wireless signal. Means for generating the sensing HR may include at least one processor of the device. As noted above, the received power may include the SI power of the radar wireless signal sensed directly from at least one transmit chain. The received power may also or alternatively include the first receive power of a reflection and/or power of any other reflections sensed on the wireless medium. The received power may also or alternatively include the noise power of the noise sensed on the wireless medium. One or more of the above mentioned powers (such as the SI power, the received/receive power, or the noise power) of the sensed overall signal may be measured by the device. The sensing HR may indicate one or more power metrics associated with the powers measured by the device 502. For example, at least a portion of the one or more power metrics may be based on the SI power.

At block 608, the device 502 provides the sensing HR to a network entity in the wireless network. Means for providing the sensing HR to the network entity may include an at least one transceiver (such as a wireless transceiver) of the device. If the device 502 is a UE 104, the network entity may be a base station 102 (e.g., a gNB) or a relay UE 104. If the sensing HR is to be provided to a base station serving the device 502, the UE 104 may provide (e.g., via a wireless transceiver) the sensing HR to the base station in an uplink MAC-CE on a NR-Uu interface (as defined by the 3GPP set of standards for 5G NR). Also or alternatively, any other suitable uplink resource may be used in providing the sensing HR. If the sensing HR is to be provided to a relay UE, the UE 104 may provide (e.g., via a wireless transceiver) the sensing HR to the relay UE in a NR-based sidelink MAC-CE (e.g., over a PC5 interface to the relay UE). Also or alternatively, any other suitable sidelink resource may be used in providing the sensing HR. In some implementations, the device 502 may unicast (e.g., via a wireless transceiver) the sensing HR to a second device (such as a base station or a relay UE). Also or alternatively, the device 502 may broadcast or groupcast (e.g., via a wireless transceiver) the sensing HR to the second device. If the sensing HR is provided to a relay UE, the relay UE may relay the sensing HR to the base station (e.g., via an uplink MAC-CE) or another relay UE until provided to the base station, and the base station may provide the sensing HR to a radar server 172 or a core network component communicably coupled to the radar server 172. If the device 502 is a base station 102 (e.g., a gNB), the network entity may be a radar server 172 or a core network component communicably coupled to the radar server 172.

Providing the sensing HR may be trigger based. In this manner, the device 502 does not provide the sensing HR to a second device (such as a base station or a relay UE) until the device 502 receives a trigger to provide the sensing HR. In some implementations, the device 502 may obtain the trigger from in a downlink control information (DCI) on a NR-Uu interface to a base station serving the device 502, and the device 502 may provide the sensing HR to the base station in response to obtaining the trigger. In some implementations, the device 502 may obtain the trigger in a sidelink control information (SCI) on a NR-based sidelink to a relay UE, and the device 502 may provide the sensing HR to the base station in response to obtaining the trigger. The trigger may be based on a request from the radar server of the wireless network. For example, the radar server 172 may determine that the radar information associated with a UE 104 is stale or may otherwise determine to request the sensing HR from the UE 104. The request may be provided to the core network 170, and a trigger may be generated and provided by a base station 102 (e.g., a gNB) towards the UE 104. In addition or alternative to providing the sensing HR being trigger based, the device 502 may periodically provide the sensing HR to the network entity. The periodicity may be determined by the device 502, the network entity, the radar server 172, or any other suitable component.

The sensing HR may be provided to a radar server 172, and the radar server 172 may determine a transmit power to be used by the device for transmitting a radar wireless signal based on the sensing HR. The device 502 may obtain a request by a radar server to adjust the present transmit power for sensing, with the adjustment based on the sensing HR previously provided by the device 502. For example, the device 502 may be requested to increase the transmit power for sensing.

Referring back to generating the sensing HR in block 606, the device 502 may determine one or more power metrics and indicate the one or more power metrics in the sensing HR. An example power metric may include a sensing headroom (with the sensing HR including an indication of the sensing headroom). The device 502 may be associated with a maximum SI power for sensing. For example, a maximum SI power may indicate the maximum SI power at which the device 502 is able to successfully sense a reflection of the radar signal and recover a digital sequence from the reflection. The sensing headroom is the difference between the SI power of the received radar signal directly from the at least one transmit chain and the maximum SI power (e.g., maximum SI power minus actual SI power). The device 502 may determine the SI power and compare the SI power to the maximum SI power to determine the sensing headroom. Determining the SI power may be performed in any suitable manner. For example, as noted above, the received power may include the SI power, the power of the reflection received, and power of the noise. The noise power may be determined by sampling the received power without transmitting. The device 502 may sample the received power once transmitting the radar signal and before sensing the reflection of the radar signal. In this manner, the received power may include the SI power and the noise power. The device 502 may subtract the determined noise power from the received power to determine the SI power. Also or alternatively, the device 502 may determine the SI power based on a variation of the received power associated with the digital sequence. The signal directly from the at least one transmit chain is received before one or more reflections, and the overall signal received may include at least two instances of the radar signal offset based on the timing difference (with each instance based on the same digital sequence, the first instance associated with the SI, and the second instance or more associated with the reflection received). The device 502 may process the overall signal to determine the first instance of the radar signal and determine the SI power. Similar to the concept of positive and negative PH values for wireless communications described above, if the maximum SI power is greater than the determined SI power, the sensing headroom may be positive. If the maximum SI power is less than the determined SI power, the sensing headroom may be negative.

In some implementations, the sensing HR may include an indication of one or more of: the SI power minus the noise; the received power minus the SI power minus the noise; or the received power minus the noise. In some implementations, the sensing HR may include an indication of a PH for sensing (also referred to as a sensing PH). The sensing PH may be a difference between a maximum transmit power for sensing and a desired transmit power for sensing. In some implementations, the maximum transmit power for sensing may be based on hardware limitations, software implemented restrictions on the transmit power, a desired maximum transmit power for the wireless network, standards considerations, or a combination of the above. For example, the maximum transmit power for sensing may be defined in firmware or otherwise set to limit the transmit power of radar signals. As noted above, the maximum transmit power for sensing may be different than a maximum transmit power for wireless communications.

In some implementations, the desired transmit power may be a transmit power for sensing determined by the device 502. As noted above, the determined transmit power may be greater than a maximum transmit power set for the device. Alternatively, the determined transmit power may be less than or equal to the maximum transmit power (in which case the device 502 may transmit the radar signal at the desired transmit power). In some implementations, the desired transmit power may be a requested transmit power (such as from a radar server 172 indicating a desired transmit power for the device). The device 502 may receive an indication of the requested transmit power from a radar server 172 if the device is a base station, or from a base station or a relay UE if the device is a UE 104. The sensing PH may be positive when the maximum transmit power for sensing is greater than the desired transmit power, and the sensing PH may be negative when the maximum transmit power for sensing is less than the desired transmit power.

While some example power metrics are described above, a sensing HR may include any other suitable power metrics that may be used in determining a transmit power or otherwise manage the device 502 supporting radar.

In some implementations, generating the sensing HR may be based on one or more parameters used to determine when a sensing HR is to be generated. For example, the device 502 may generate a sensing HR for each sensing attempt of a reflection of a transmitted radar signal regardless of being successful or not successful. An example parameter may include a sensing attempt occurring. In another example, the device 502 may generate a sensing HR for each successful sensing attempt of a reflection of a transmitted radar signal. An example parameter may include a successful sensing attempt occurring. Other parameters may be a periodicity of performing radar, specific time windows during which radar is to be performed, specific frequencies (such as specific bands or subbands) at which radar is to be performed.

The sensing HR may be in different formats. In some implementations, the one or more parameters may indicate a format of the sensing HR. The sensing HR may include an indication of one or more power metrics determined by the device 502. In one implementation, the sensing HR may include one or more power metrics from a single sensing attempt. In another implementation, the sensing HR may be an aggregate report including power metrics across multiple sensing attempts. The multiple sensing attempts may be at the same transmit frequency or may be across different transmit frequencies. If at the same frequency, the multiple sensing attempts are over time. If at different frequencies, the multiple sensing attempts may be over time or concurrent. In an example of the aggregate report being for multiple sensing attempts across frequencies, the sensing HR may include a subband sensing HR aggregating power metrics from multiple sensing attempts across different subbands.

In one format of a sensing HR, the sensing HR may include a sensing PH value or a sensing headroom value as determined by the device 502. Another format of the sensing HR may be that the value indicated by the sensing HR is a difference from a PH value for wireless communications indicated in a power HR for wireless communications. For example, the device 502 may generate a power HR for wireless communications by a UE (as defined in the 3GPP set of standards for 5G NR), and the device 502 may provide the power HR to the network entity (e.g., a gNB or a relay UE) with the power HR indicates a first power measurement associated with communication on the wireless medium. The device 502 may determine a sensing headroom, sensing PH, or other second power measurement associated with sensing on the wireless medium. A differential sensing HR may indicate a difference between the first power measurement from the power HR and the second power measurement. For example, the differential sensing HR may indicate a PH associated with wireless communications minus a sensing PH or minus a sensing headroom. The one or more parameters for generating the sensing HR may indicate the format of the sensing HR to be generated. Other example parameters are the transmit power to be used or the power metrics to be indicated in the sensing HR.

The one or more parameters may be stored at the device 502 and used in generating the sensing HR. At least a portion of the parameters or an adjustment to the parameters may be indicated to the device 502. For example, a radar server 172 may determine a format of the sensing HR to be received, and the format may be indicated to the device 502. The indication of one or more parameters may be obtained by the device 502, and the device 502 may configure the one or more parameters at the device 502 based on the indication. In this manner, the sensing HR can be periodically updated. In some implementations, the indication is obtained in a MAC-CE on a NR-Uu interface to a gNB serving the device 502 or a NR-based sidelink between the device 502 and a relay UE. With the device 502 configuring the one or more parameters, one or more sensing HRs may be generated based on the configured one or more parameters. In some implementations, the configuration of the one or more parameters is persisted (such as for one or more sensing HRs) until another indication of the one or more parameters is obtained by the device 502. For example, the radar server 172 may later determine to adjust the format, periodicity, etc. of the sensing HR to be received, and the adjustment may be indicated to the device 502. In some implementations, indications of the one or more parameters may be obtained periodically by the device 502. For example, the device 502 may periodically receive an indication in one or more of a radio resource control (RRC) message from a gNB serving the device 502, a LTE positioning protocol (LPP) message from the gNB serving the device 502, or a message on a NR-based sidelink.

The device 502 may determine or adjust the transmit power to be used for transmitting the radar wireless signals to improve sensing of the reflections (which may improve the ability of determining the distances of objects from the device 502).

FIG. 8 shows a flowchart for an example method 800 for determining a final transmit power for transmitting a radar wireless signal. The final transmit power may be a minimum or a reduced transmit power than other transmit powers at which the device 502 is able to successfully sense a reflection of a radar wireless signal transmitted at the final transmit power. Successfully sensing a reflection may refer to the device 502 being able to recover the digital sequence sufficiently to determine a distance of an object, a RTT of the signal, etc., based on the reflection. The exemplary method 800 may be performed by any suitable device 502 of a wireless network, such as base station 102 or 400 shown in FIGS. 1 and 4 or a UE 104 or 300 shown in FIGS. 1 and 3 in a wireless network (e.g., a cellular network), in a manner consistent with disclosed implementations. For example, a device that may perform one or more operations in method 800 may include at least one transceiver (such as one or more wireless transceivers and/or one or more wired transceivers), at least one memory, and at least one processor coupled to the at least one transceiver and the at least one memory. Referring to the UE 300 as an example device, the at least one transceiver may include the transceiver 315 or the wireless transceiver 340, the at least one memory may include the memory 311, and the at least one processor may include the processor 310 or one or more of processors 330-334. Referring to the base station 400 as an example device, the at least one transceiver may include the transceiver 415 or the wireless transceiver 440, the at least one memory may include the memory 411, and the at least one processor may include the processor 410.

At block 802, the device 502 sets a transmit power for transmitting the radar wireless signal to an initial transmit power. Means for setting the transmit power may include at least one transceiver (e.g., a wireless transceiver), at least one processor, or a combination of both of the device. The initial transmit power may be a minimum transmit power or any other suitable transmit power to be used for sensing. The initial transmit power may be defined in software or firmware, may be based on a hardware limitation, or otherwise may be predetermined for the device 502.

At block 804, the device 502 transmits a radar wireless signal at the transmit power. Means for transmitting the radar wireless signal may include at least one transceiver (e.g., a wireless transceiver) of the device. Transmitting the radar wireless signal in block 804 may be similar to block 602 in FIG. 6.

At block 806, the device 502 attempts to sense a reflection of the radar wireless signal. Means for attempting to sense the reflection of the radar wireless signal may include at least one transceiver (e.g., a wireless transceiver) of the device.

At decision block 808, if a reflection is successfully sensed, the process continues to block 810. If a reflection is not successfully sensed, the process continues to decision block 812. Means for determining whether the reflection is successfully sensed may include at least one processor of the device.

At block 810, the device 502 determines the current transmit power as the final transmit power to be used for transmitting radar wireless signals. Means for determining the current transmit power as the final transmit power may include at least one processor of the device. As noted above, the final transmit power may be a minimum transmit power at which the device 502 is able to successfully sense a reflection of the radar wireless signal transmitted at the final transmit power.

At decision block 812, the device 502 determines if a maximum number of repetitions of transmitting the radar wireless signal at the same transmit power is reached. Means for determining if the maximum number of repetitions of transmitting the radar wireless signal may include at least one processor of the device. The maximum number of repetitions may be any integer greater than or equal to 1. For example, reflections of one transmission instance of a radar wireless signal may be prevented from being sensed and successfully recovered because of a temporary interference. If the device 502 is unable to sense the reflection of the radar wireless signal from a first transmission instance, the device 502 may repeat transmitting the radar wireless signal until the device 502 successfully senses a reflection of the radar wireless signal or the maximum number of repetitions is reached. If the maximum number of repetitions is not yet reached, the process reverts back to block 804, and the device 502 retransmits the radar wireless signal at the transmit power and attempts to sense a reflection of the radar wireless signal. If the maximum number of repetitions is reached, the device 502 determines that the one or more sensing attempts at the same transmit power failed, and the process continues to decision block 814. The maximum number repetitions may be a tradeoff between time and power resources to attempt sensing a radar signal at the same transmit power before increasing the transmit power. The maximum number of repetitions may be one of the parameters associated with sensing radar signals. The maximum number of repetitions may be defined at the device 502, by the radar server 172, by another component of the wireless network, or may be determined in any suitable manner. In some implementations, the device 502 uses a transmission counter to keep track of the number of transmissions at the same transmit power. The device 502 may determine if the maximum number of repetitions is reached by comparing the transmission counter to the maximum number.

At decision block 814, the device 502 determines if a maximum transmit power for sensing is reached. Means for determining if a maximum transmit power for sensing is reached may include at least one processor of the device. For example, if the current transmit power equals the maximum transmit power for sensing, the device 502 may not increase the current transmit power. In this manner, the example method 800 may end. In some implementations, the device 502 may indicate to the network entity that sensing failed or that the device 502 is temporarily terminating, suspending, or delaying transmitting radar signals and attempting to sense reflections of the radar signals. If power is increased in discrete steps (which may be referred to as power ramping steps), the device 502 may determine if the maximum transmit power for sensing equals the current transmit power by comparing a number of steps the transmit power has been increased from the initial transmit power to the total number of steps to reach the maximum transmit power for sensing. For example, the device 502 may use a power ramping counter to count the number of power ramping steps, and the device 502 may compare the power ramping counter to a defined maximum number of power ramping steps stored at the device 502. If the power ramping counter value equals the maximum number, the maximum transmit power is reached. If the power ramping counter value is less than the maximum number, the maximum transmit power is not reached. In another implementation, the device 502 may compare the current transmit power to a determined maximum transmit power.

At block 816, the device 502 increases the transmit power. Means for increasing the transmit power may include one or more of at least one transceiver or at least one processor of the device. For example, the device 502 may increase the transmit power by a power ramping step (at block 818). A power ramping step may be any suitable discrete step in increasing the transmit power. The steps may be evenly separated, may decrease when approaching the maximum transmit power for sensing, or may be spaced in any other suitable manner. The device 502 may also use any number of steps between the initial transmit power and the maximum transmit power. The number of steps to be used may be a tradeoff between fidelity in determining the final transmit power (with more steps increasing the fidelity in tuning the final transmit power) and processing resources and time (with more steps requiring additional transmissions and processing by the device 502, which take more time). If the transmit power is increased by a power ramping step, the power ramping counter value may be incremented. After increasing the transmit power (at block 816), the process reverts to block 804, and the device 502 transmits the radar wireless signal at the increased transmit power. If a transmission counter is used to count transmissions at the same transmit power, the transmission counter may be reset.

If the device 502 performs method 800, the device 502 may recursively increase the transmit power based on the one or more sensing attempts failing, transmit the radar wireless signal one or more times at an increased transmit power, and attempt to sense the reflection of the radar wireless signal until the first device successfully senses the reflection of the radar wireless signal (or the transmit power cannot be further increased). The increased transmit power used for the successful sensing attempt is the final transmit power for sensing.

In some implementations, the device 502 may restrict the sensing attempts to a maximum number of transmissions to be performed before determining or indicating that sensing has failed. The maximum number of transmissions may be at one transmit power or across multiple transmit powers. For example, while not shown in FIG. 8, the device 502 (such as at least one processor of the device) may count the total number of sensing attempts across the different transmit powers used and compare the total number to the maximum number of transmissions. If the total number equals the maximum number of transmissions, the device 502 may determine that sensing is to be temporarily terminated, suspended, or delayed. The maximum number of transmissions may be a tradeoff between processing resources/time and successfully sensing a reflection to determine an object's distance, a RTT, or another metric.

One or more device parameters for determining a final transmit power may include one or more of the maximum number of transmissions for sensing before determining or indicating sensing has failed, a power ramping step to be used to increase the transmit power for sensing, a transmission counter for sensing, an initial transmit power for sensing, or a maximum number of repetitions at the same transmit power for sensing. A sensing HR may be associated with or may indicate any of the one or more device parameters for determining the final transmit power. For example, a sensing HR may include an indication of one or more of the initial transmit power, the power ramping step, the maximum number of transmissions at the same transmit power, or an overall maximum number of transmissions to be performed before the device 502 is to determine that sensing has failed. If a final transmit power cannot be determined, the sensing HR may indicate an error or that sensing failed. In some implementations, one or more of the device parameters may be indicated to the device 502 (such as from a radar server 172), and the device 502 may adjust the one or more device parameters for determining the final transmit power.

The device 502 may generate and provide one or more sensing HRs while performing the operations of method 800. For example, the device 502 may generate one or more sensing HRs for one or more failed sensing attempts and provide the one or more sensing HRs to the network entity (such as a gNB, a relay UE, or the radar server). The one or more sensing HRs for the one or more failed sensing attempts may include indications of one or more of the transmit power, the transmission counter, or the power ramping counter. The one or more sensing HRs may be used by the radar server or another device to determine one or more of the device parameters to adjust the method 800. For example, if sensing at the initial transmit power continuously fails, the radar server may indicate an increase to the initial transmit power.

As describe above, different implementations exist for a device to generate a sensing HR, to determine a final transmit power for transmitting radar signals, and to otherwise perform one or more radar operations. Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Implementation examples are described in the following numbered clauses:
1. A method of generating a sensing headroom report (HR) by a first device in a wireless network, including:
transmitting a radio detection and ranging (radar) wireless signal on a wireless medium at a first transmit power from one or more transmit chains of the first device;
sensing the radar wireless signal;
generating a sensing HR based on sensing the radar wireless signal; and
providing the sensing HR to a network entity in the wireless network.
2. The method of clause 1, where sensing the radar wireless signal includes sensing the radar wireless signal directly from at least one of the one or more transmit chains of the first device, where a measured self-interference (SI) power of the sensed radar wireless signal corresponds to the radar wireless signal sensed directly from the at least one of the one or more transmit chains of the first device.
3. The method of one or more of clauses 1-2, where the sensing HR includes an indication of a sensing headroom, where the sensing headroom is a difference between the SI power and a maximum SI power for sensing.
4. The method of one or more of clauses 1-3, where:
the sensing headroom is positive when the maximum SI power is greater than the SI power; and
the sensing headroom is negative when the maximum SI power is less than the SI power.
5. The method of one or more of clauses 1-2, where sensing the radar wireless signal further includes:
sensing a reflection of the radar wireless signal on the wireless medium, where a measured first received power of the reflection of the radar wireless signal corresponds to the reflection sensed on the wireless medium; and
sensing a noise on the wireless medium, where:
a measured noise power corresponds to the noise sensed on the wireless medium; and
the sensing HR includes an indication of one or more of:
   the SI power minus the noise power;
   the received power minus the SI power minus the noise power; or
   the received power minus the noise power.
6. The method of one or more of clauses 1-2, where the sensing HR includes an indication of a power headroom (PH) for sensing, where the PH for sensing is a difference between a maximum transmit power for sensing and a
desired transmit power for sensing.
7. The method of one or more of clauses 1-6, where:
the PH for sensing is positive when the maximum transmit power for sensing is greater than the desired transmit power; and the PH for sensing is negative when the maximum transmit power for sensing is less than the desired transmit power.
8 The method of one or more of clauses 1-6, where the desired transmit power for sensing is one of:
a transmit power for sensing determined by the first device; or
a requested transmit power, where an indication of the requested transmit power is obtained from one of:
a radar server of the wireless network, where the first device is a base station;
a base station serving the first device, where the first device is a user equipment (UE); or a relay UE, where the first device is a UE within range of the relay UE.
9. The method of clause 1, further including:
obtaining a request by a radar server of the wireless network to adjust a present transmit power for sensing, where the adjustment is based on the sensing HR.
10. The method of clause 1, where providing the sensing HR to the network entity includes one of:
unicasting the sensing HR to a second device in the wireless network;
broadcasting the sensing HR to the second device;
groupcasting the sensing HR to the second device; or
sending the sensing HR to a radar server of the wireless network, where the first device is a base station.
11. The method of one or more of clauses 1-10, where the second device is one of:
a base station serving the first device; or
a relay UE between the first device and a base station of the wireless network.
12. The method of one or more of clauses 1-11, where the sensing HR is provided in one or more of:
an uplink (UL) media access control layer control element (MAC-CE) on a NR-Uu interface to the base station; or
a NR-based sidelink MAC-CE to the relay UE.
13. The method of clause 1, further including obtaining a trigger to provide the sensing HR, where:
the trigger is obtained in one of:
downlink control information (DCI) on a NR-Uu interface to a base station serving the first device; or
sidelink control information (SCI) on a NR-based sidelink;
the sensing HR is provided to the network entity in response to obtaining the trigger; and
the trigger is based on a request from a radar server of the wireless network for the sensing HR from the first device.
14. The method of clause 1, where the sensing HR is provided periodically to the network entity.
15. The method of clause 1, further including obtaining an indication of one or more parameters for generating the sensing HR.
16. The method of one or more of clauses 1-15, where:
the indication is obtained in a media access control layer control element (MAC-CE) on a NR-Uu interface to a base station serving the first device or on a NR-based sidelink; and
configuration of the one or more parameters is persisted for one or more sensing HRs until another indication of the one or more parameters is obtained.
17. The method of one or more of clauses 1-15, where indications of the one or more parameters are obtained periodically in one or more of:
a radio resource control (RRC) message from a base station serving the first device;
a long-term evolution (LTE) positioning protocol (LPP) message from the base station serving the first device; or
a message on a NR-based sidelink.
18. The method of clause 1, further including:
generating a power HR, where the power HR indicates a first power measurement associated with communication on the wireless medium; and
providing the power HR to the network entity, where the sensing HR indicates a difference between the first power measurement and a second power measurement associated with sensing on the wireless medium.
19. The method of clause 1, where the sensing HR is an aggregate report indicating a plurality of power measurements over multiple sensing attempts.
20. The method of one or more of clauses 1-19, where the multiple sensing attempts include one of:
multiple sensing attempts at the same transmit frequency over time; or
multiple sensing attempts, where each sensing attempt is at a different transmit frequency.
21. The method of clause 1, further including determining a final transmit power for sensing, where determining the final transmit power includes:
setting a transmit power for transmitting the radar wireless signal to an initial transmit power;
transmitting a radar wireless signal one or more times at the transmit power;
attempting to sense a reflection of the radar wireless signal; and
recursively increasing the transmit power by a power ramping step based on the one or more sensing attempts failing, transmitting the radar wireless signal one or more times at an increased transmit power, and attempting to sense the reflection of the radar wireless signal until the first device successfully senses the reflection of the radar wireless signal, where the increased transmit power used for the successful sensing attempt is the final transmit power for sensing.
22. The method of one or more of clauses 1-21, where the radar wireless signal is transmitted up to a maximum number of transmissions at a same transmit power before determining that the one or more sensing attempts failed at the same transmit power.
23. The method of one or more of clauses 1-22, further including:
generating one or more sensing HRs for the one or more failed sensing attempts; and
providing the one or more sensing HRs to the network entity.
24. The method of one or more of clauses 1-23, where the one or more sensing HRs for the one or more failed sensing attempts include one or more indications of:
the transmit power;
a transmission counter of a number of transmissions by the first device at the same transmit power; or
a power ramping counter of a number of times the transmit power has been increased by the power ramping step.
25. The method of one or more of clauses 1-22, further including obtaining an indication of one or more device parameters to be configured by the first device for sensing, where the one or more device parameters include one or more of:
the initial transmit power;
the power ramping step;
the maximum number of transmissions at the same transmit power; or
an overall maximum number of transmissions to be performed before the first device is to determine that sensing has failed.
26. The method of clause 1, where the first device is a user equipment (UE).
27. The method of one or more of clauses 1-26, where the network entity is one or more of:
a base station serving the UE; or
one or more neighboring UEs within range of the UE.
28. The method of clause 1, where the first device is a base station and the network entity is a radar server.
29. A device in a wireless network configured for generating a sensing headroom report (HR), including:
at least one transceiver;
at least one memory; and
at least one processor coupled to the at least one transceiver and the at least one memory, where the at least one processor is configured to cause the device to:
transmit, via the at least one transceiver, a radio detection and ranging (radar) wireless signal on a wireless medium at a first transmit power from one or more transmit chains of the device;
sense, via the at least one transceiver, the radar wireless signal;
generate, via the at least one processor, the sensing HR based on sensing the radar wireless signal; and
provide, via the at least one transceiver, the sensing HR to a network entity in the wireless network.
30. The device of clause 29, where sensing the radar wireless signal includes sensing the radar wireless signal directly from at least one of the one or more transmit chains of the first device, where a measured self-interference (SI) power of the sensed radar wireless signal corresponds to the radar wireless signal sensed directly from the at least one of the one or more transmit chains of the first device.
31. The device of one or more of clauses 29-30, where the sensing HR includes an indication of a sensing headroom, where the sensing headroom is a difference between the SI power and a maximum SI power for sensing.
32. The device of one or more of clauses 29-31, where:
the sensing headroom is positive when the maximum SI power is greater than the SI power; and
the sensing headroom is negative when the maximum SI power is less than the SI power.
33. The device of one or more of clauses 29-30, where:
the at least one processor is configured to further cause the device to:
sense, via the at least one transceiver, a reflection of the radar wireless signal on the wireless medium, where a measured first received power of the reflection of the radar wireless signal corresponds to the reflection sensed on the wireless medium; and
sense, via the at least one transceiver, a noise associated with sensing the reflection, where:
a measured noise power corresponds to the noise sensed on the wireless medium; and
the sensing HR includes an indication of one or more of:
   the SI power minus the noise power;
   the received power minus the SI power minus the noise power; or
   the received power minus the noise power.
34. The device of one or more of clauses 29-30, where the sensing HR includes an indication of a power headroom (PH) for sensing, where the PH for sensing is a difference between a maximum transmit power for sensing and a desired transmit power for sensing.
35. The device of one or more of clauses 29-34, where:
the PH for sensing is positive when the maximum transmit power for sensing is greater than the desired transmit power; and
the PH for sensing is negative when the maximum transmit power for sensing is less than the desired transmit power.
36. The device of one or more of clauses 29-34, where the desired transmit power for sensing is one of:
a transmit power for sensing determined by the device; or
a requested transmit power, where an indication of the requested transmit power is obtained from one of:
a radar server of the wireless network, where the device is a base station;
a base station serving the device, where the device is a user equipment (UE); or
a relay UE, where the device is a UE within range of the relay UE.
37. The device of clause 29, where the at least one processor is configured to further cause the device to obtain, via the at least one transceiver, a request by a radar server of the wireless network to adjust a present transmit power for sensing, where the adjustment is based on the sensing HR.
38. The device of clause 29, where providing the sensing HR to the network entity includes one of:
unicasting the sensing HR to a second device in the wireless network;
broadcasting the sensing HR to the second device;
groupcasting the sensing HR to the second device; or
sending the sensing HR to a radar server of the wireless network, where the device is a base station.

39. The device of one or more of clauses 29-38, where the second device is one of:
a base station serving the device; or
a relay UE between the first device and a base station of the wireless network.

40. The device of one or more of clauses 29-39, where the sensing HR is provided in one or more of:
an uplink (UL) media access control layer control element (MAC-CE) on a NR-Uu interface to the base station; or
a NR-based sidelink MAC-CE to the relay UE.

41. The device of clause 29, where the at least one processor is configured to further cause the device to obtain, via the at least one transceiver, a trigger to provide the sensing HR, where:
the trigger is obtained in one of:
downlink control information (DCI) on a NR-Uu interface to a base station serving the device; or
sidelink control information (SCI) on a NR-based sidelink;
the sensing HR is provided to the network entity in response to obtaining the trigger; and
the trigger is based on a request from a radar server of the wireless network for the sensing HR from the device.
42. The device of clause 29, where the at least one processor is configured to further cause the device to provide, via the at least one transceiver, a sensing HR periodically to the network entity.
43. The device of clause 29, where the at least one processor is configured to further cause the device to obtain, via the at least one transceiver, an indication of one or more parameters for generating the sensing HR.
44. The device of one or more of clauses 29-43, where:
the indication is obtained in a media access control layer control element (MAC-CE) on a NR-Uu interface to a base station serving the device or on a NR-based sidelink; and
configuration of the one or more parameters is persisted for one or more sensing HRs until another indication of the one or more parameters is obtained.
45. The device of one or more of clauses 29-43, where indications of the one or more parameters are obtained periodically in one or more of:
a radio resource control (RRC) message from a base station serving the device;
a long-term evolution (LTE) positioning protocol (LPP) message from the base station serving the device; or
a message on a NR-based sidelink.
46. The device of clause 29, where:
the at least one processor is configured to further cause the device to:
generate, via the at least one processor, a power HR, where the power HR indicates a first power measurement associated with communication on the wireless medium; and
provide, via the at least one transceiver, the power HR to the network entity, where the sensing HR indicates a difference between the first power measurement and a second power measurement associated with sensing on the wireless medium.
47. The device of clause 29, where the sensing HR is an aggregate report indicating a plurality of power measurements over multiple sensing attempts.
48. The device of one or more of clauses 29-47, where the multiple sensing attempts include one of:
multiple sensing attempts at the same transmit frequency over time; or
multiple sensing attempts, where each sensing attempt is at a different transmit frequency.
49. The device of clause 29, where the at least one processor is configured to further cause the device to determine, via the at least one processor, a final transmit power for sensing, where determining the final transmit power includes:
setting a transmit power for transmitting the radar wireless signal to an initial transmit power;
transmitting, via the at least one transceiver, a radar wireless signal one or more times at the transmit power;
attempting, via the at least one transceiver, to sense a reflection of the radar wireless signal; and
recursively increasing the transmit power by a power ramping step based on the one or more sensing attempts failing, transmitting, via the at least one transceiver, the radar wireless signal one or more times at an increased transmit power, and attempting, via the at least one transceiver, to sense the reflection of the radar wireless signal until the device successfully senses the reflection of the radar wireless signal, where the increased transmit power used for the successful sensing attempt is the final transmit power for sensing.
50. The device of one or more of clauses 29-49, where the at least one processor is configured to further cause the device to transmit, via the at least one transceiver, the radar wireless signal up to a maximum number of transmissions at a same transmit power before determining that the one or more sensing attempts failed at the same transmit power.
51. The device of one or more of clauses 29-50, where:
the at least one processor is configured to further cause the device to:
generate, via the at least one processor, one or more sensing HRs for the one or more failed sensing attempts; and
provide, via the at least one processor, the one or more sensing HRs to the network entity.
52. The device of one or more of clauses 29-51, where the one or more sensing HRs for the one or more failed sensing attempts include one or more indications of:
the transmit power;
a transmission counter of a number of transmissions by the device at the same transmit power; or
a power ramping counter of a number of times the transmit power has been increased by the power ramping step.
53. The device of one or more of clauses 29-50, where the at least one processor is configured to further cause the device to obtain, via the at least one transceiver, an indication of one or more device parameters to be configured by the device for sensing, where the one or more device parameters include one or more of:
the initial transmit power;
the power ramping step;
the maximum number of transmissions at the same transmit power; or
an overall maximum number of transmissions to be performed before the device is to determine that sensing has failed.
54. The device of clause 29, where the device is a user equipment (UE).
55. The device of one or more of clauses 29-54, where the network entity is one of:
a base station serving the UE; or
one or more neighboring UEs within range of the UE.
56. The device of clause 29, where the device is a base station and the network entity is a radar server.
57. A non-transitory computer-readable medium storing instructions that, when executed by at least one processor of a device in a wireless network configured for generating a sensing headroom report (HR), causes the device to:
transmit, via at least one transceiver of the device, a radio detection and ranging (radar) wireless signal on a wireless medium at a first transmit power from one or more transmit chains of the device;
sense, via the at least one transceiver, the radar wireless signal;
generate, via the at least one processor, the sensing HR based on sensing the radar wireless signal; and
provide, via the at least one transceiver, the sensing HR to a network entity in the wireless network.
58. The computer-readable medium of clause 57, where sensing the radar wireless signal includes sensing the radar wireless signal directly from at least one of the one or more transmit chains of the first device, where a measured self-interference (SI) power of the sensed radar wireless signal corresponds to the radar wireless signal sensed directly from the at least one of the one or more transmit chains of the first device.
59. The computer-readable medium of one or more of clauses 57-58, where the sensing HR includes an indication of a sensing headroom, where the sensing headroom is a difference between the SI power and a maximum SI power for sensing.
60. The computer-readable medium of one or more of clauses 57-59, where:
the sensing headroom is positive when the maximum SI power is greater than the SI power; and
the sensing headroom is negative when the maximum SI power is less than the SI power.
61. The computer-readable medium of one or more of clauses 57-58, where:
execution of the instructions further causes the device to:
sense, via the at least one transceiver, a reflection of the radar wireless signal on the wireless medium, where a measured first received power of the reflection of the radar wireless signal corresponds to the reflection sensed on the wireless medium; and
sense, via the at least one transceiver, a noise associated with sensing the reflection, where:
a measured noise power corresponds to the noise sensed on the wireless medium; and
the sensing HR includes an indication of one or more of:
   the SI power minus the noise power;
   the received power minus the SI power minus the noise power; or
   the received power minus the noise power.
62. The computer-readable medium of one or more of clauses 57-58, where the sensing HR includes an indication of a power headroom (PH) for sensing, where the PH for sensing is a difference between a maximum transmit power for sensing and a desired transmit power for sensing.
63. The computer-readable medium of one or more of clauses 57-62, where:
the PH for sensing is positive when the maximum transmit power for sensing is greater than the desired transmit power; and
the PH for sensing is negative when the maximum transmit power for sensing is less than the desired transmit power.
64. The computer-readable medium of one or more of clauses 57-62, where the desired transmit power for sensing is one of:
a transmit power for sensing determined by the device; or
a requested transmit power, where an indication of the requested transmit power is obtained from one of:
a radar server of the wireless network, where the device is a base station;
a base station serving the device, where the device is a user equipment (UE); or
a relay UE, where the device is a UE within range of the relay UE.
65. The computer-readable medium of clause 57, where execution of the instructions further causes the device to obtain, via the at least one transceiver, a request by a radar server of the wireless network to adjust a present transmit power for sensing, where the adjustment is based on the sensing HR.
66. The computer-readable medium of clause 57, where providing the sensing HR to the network entity includes one of:
unicasting the sensing HR to a second device in the wireless network;
broadcasting the sensing HR to the second device;
groupcasting the sensing HR to the second device; or
sending the sensing HR to a radar server of the wireless network, where the device is a base station.
67. The computer-readable medium of one or more of clauses 57-64, where the second device is one of:
a base station serving the device; or
a relay UE between the first device and a base station of the wireless network.
68. The computer-readable medium of one or more of clauses 57-67, where the sensing HR is provided in one or more of:
an uplink (UL) media access control layer control element (MAC-CE) on a NR-Uu interface to the base station; or
a NR-based sidelink MAC-CE to the relay UE.
69. The computer-readable medium of clause 57, where execution of the instructions further causes the device to obtain, via the at least one transceiver, a trigger to provide the sensing HR, where:
the trigger is obtained in one of:
downlink control information (DCI) on a NR-Uu interface to a base station serving the device; or
sidelink control information (SCI) on a NR-based sidelink;
the sensing HR is provided to the network entity in response to obtaining the trigger; and
the trigger is based on a request from a radar server of the wireless network for the sensing HR from the device.
70. The computer-readable medium of clause 57, where execution of the instructions further causes the device to provide, via the at least one transceiver, a sensing HR periodically to the network entity.
71. The computer-readable medium of clause 57, where execution of the instructions further causes the device to obtain, via the at least one transceiver, an indication of one or more parameters for generating the sensing HR.
72. The computer-readable medium of one or more of clauses 57-71, where:
the indication is obtained in a media access control layer control element (MAC-CE) on a NR-Uu interface to a base station serving the device or on a NR-based sidelink; and
configuration of the one or more parameters is persisted for one or more sensing HRs until another indication of the one or more parameters is obtained.
73. The computer-readable medium of one or more of clauses 57-71, where indications of the one or more parameters are obtained periodically in one or more of:
a radio resource control (RRC) message from a base station serving the device;
a long-term evolution (LTE) positioning protocol (LPP) message from the base station serving the device; or a message on a NR-based sidelink.
74. The computer-readable medium of clause 57, where:
execution of the instructions further causes the device to:
generate, via the at least one processor, a power HR, where the power HR indicates a first power measurement associated with communication on the wireless medium; and
provide, via the at least one transceiver, the power HR to the network entity, where the sensing HR indicates a difference between the first power measurement and a second power measurement associated with sensing on the wireless medium.
75. The computer-readable medium of clause 57, where the sensing HR is an aggregate report indicating a plurality of power measurements over multiple sensing attempts.
76. The computer-readable medium of one or more of clauses 57-75, where the multiple sensing attempts include one of:
multiple sensing attempts at the same transmit frequency over time; or
multiple sensing attempts, where each sensing attempt is at a different transmit frequency.
77. The computer-readable medium of clause 57, where execution of the instructions further causes the device to determine, via the at least one processor, a final transmit power for sensing, where determining the final transmit power includes:
setting a transmit power for transmitting the radar wireless signal to an initial transmit power;
transmitting, via the at least one transceiver, a radar wireless signal one or more times at the transmit power;
attempting, via the at least one transceiver, to sense a reflection of the radar wireless signal; and
recursively increasing the transmit power by a power ramping step based on the one or more sensing attempts failing, transmitting, via the at least one transceiver, the radar wireless signal one or more times at an increased transmit power, and attempting, via the at least one transceiver, to sense the reflection of the radar wireless signal until the device successfully senses the reflection of the radar wireless signal, where the increased transmit power used for the successful sensing attempt is the final transmit power for sensing.
78. The computer-readable medium of one or more of clauses 57-77, where execution of the instructions further causes the device to transmit, via the at least one transceiver, the radar wireless signal up to a maximum number of transmissions at a same transmit power before determining that the one or more sensing attempts failed at the same transmit power.
79. The computer-readable medium of one or more of clauses 57-78, where:
execution of the instructions further causes the device to:
generate, via the at least one processor, one or more sensing HRs for the one or more failed sensing attempts; and
provide, via the at least one processor, the one or more sensing HRs to the network entity.
80. The computer-readable medium of one or more of clauses 57-79, where the one or more sensing HRs for the one or more failed sensing attempts include one or more indications of:
the transmit power;
a transmission counter of a number of transmissions by the device at the same transmit power; or
a power ramping counter of a number of times the transmit power has been increased by the power ramping step.
81. The computer-readable medium of one or more of clauses 57-78, where execution of the instructions further causes the device to obtain, via the at least one transceiver, an indication of one or more device parameters to be configured by the device for sensing, where the one or more device parameters include one or more of:
   the initial transmit power;
   the power ramping step;
   the maximum number of transmissions at the same transmit power; or
   an overall maximum number of transmissions to be performed before the device is to determine that sensing has failed.
82. The computer-readable medium of clause 57, where the device is a user equipment (UE).
83. The computer-readable medium of one or more of clauses 57-82, where the network entity is one of:
a base station serving the UE; or one or more neighboring UEs within range of the UE.
84. The computer-readable medium of clause 57, where the device is a base station and the network entity is a radar server.
85. A device for generating a sensing headroom report (HR) in a wireless network, including:
means for transmitting a radio detection and ranging (radar) wireless signal on a wireless medium at a first transmit power from one or more transmit chains;
means for sensing the radar wireless signal;
means for generating a sensing HR based on sensing the radar wireless signal; and
means for providing the sensing HR to a network entity in the wireless network.
86. The device of clause 85, where the means for sensing the radar wireless signal includes means for sensing the radar wireless signal directly from at least one of the one or more transmit chains, where a measured self-interference (SI) power of the sensed radar wireless signal corresponds to the radar wireless signal sensed directly from the at least one of the one or more transmit chains.
87. The device of one or more of clauses 85-86, where the sensing HR includes an indication of a sensing headroom, where the sensing headroom is a difference between the SI power and a maximum SI power for sensing.
88. The device of one or more of clauses 85-87, where:
the sensing headroom is positive when the maximum SI power is greater than the SI power; and
the sensing headroom is negative when the maximum SI power is less than the SI power.
89. The device of one or more of clauses 85-86, where the means for sensing the radar wireless signal further includes:
means for sensing a reflection of the radar wireless signal on the wireless medium, where a measured first received power of the reflection of the radar wireless signal corresponds to the reflection sensed on the wireless medium; and
means for sensing a noise on the wireless medium, where:
a measured noise power corresponds to the noise sensed on the wireless medium; and
the sensing HR includes an indication of one or more of:
   the SI power minus the noise power;
   the received power minus the SI power minus the noise power; or
   the received power minus the noise power.
90. The device of one or more of clauses 85-86, where the sensing HR includes an indication of a power headroom (PH) for sensing, where the PH for sensing is a difference between a maximum transmit power for sensing and a desired transmit power for sensing.
91. The device of one or more of clauses 85-90, where:
the PH for sensing is positive when the maximum transmit power for sensing is greater than the desired transmit power; and
the PH for sensing is negative when the maximum transmit power for sensing is less than the desired transmit power.
92. The device of one or more of clauses 85-90, where the desired transmit power for sensing is one of:

a transmit power for sensing determined by the device; or
a requested transmit power, where an indication of the requested transmit power is obtained from one of:
a radar server of the wireless network, where the device is a base station;
a base station serving the device, where the device is a user equipment (UE); or
a relay UE, where the device is a UE within range of the relay UE.
93. The device of clause 85, further including:
means for obtaining a request by a radar server of the wireless network to adjust a present transmit power for sensing, where the adjustment is based on the sensing HR.
94. The device of clause 85, where the means for providing the sensing HR to the network entity includes one of:
means for unicasting the sensing HR to a second device in the wireless network;
means for broadcasting the sensing HR to the second device;
means for groupcasting the sensing HR to the second device; or
means for sending the sensing HR to a radar server of the wireless network, where the device is a base station.

95. The device of one or more of clauses 85-94, where the second device is one of:
a base station serving the device; or
a relay UE between the device and a base station of the wireless network.

96. The device of one or more of clauses 85-95, where the sensing HR is provided in one or more of:
an uplink (UL) media access control layer control element (MAC-CE) on a NR-Uu interface to the base station; or
a NR-based sidelink MAC-CE to the relay UE.

97. The device of clause 85, further including means for obtaining a trigger to provide the sensing HR, where:
the trigger is obtained in one of:
downlink control information (DCI) on a NR-Uu interface to a base station serving the device; or
sidelink control information (SCI) on a NR-based sidelink;
the sensing HR is provided to the network entity in response to obtaining the trigger; and
the trigger is based on a request from a radar server of the wireless network for the sensing HR from the device.
98. The device of clause 85, where the sensing HR is provided periodically to the network entity.
99. The device of clause 85, further including means for obtaining an indication of one or more parameters for generating the sensing HR.
100. The device of one or more of clauses 85-99, where:
the indication is obtained in a media access control layer control element (MAC-CE) on a NR-Uu interface to a base station serving the device or on a NR-based sidelink; and
configuration of the one or more parameters is persisted for one or more sensing HRs until another indication of the one or more parameters is obtained.
101. The device of one or more of clauses 85-99, where indications of the one or more parameters are obtained periodically in one or more of:
a radio resource control (RRC) message from a base station serving the device;
a long-term evolution (LTE) positioning protocol (LPP) message from the base station serving the device; or
a message on a NR-based sidelink.
102. The device of clause 85, further including:
means for generating a power HR, where the power HR indicates a first power measurement associated with communication on the wireless medium; and
means for providing the power HR to the network entity, where the sensing HR indicates a difference between the first power measurement and a second power measurement associated with sensing on the wireless medium.
103. The device of clause 85, where the sensing HR is an aggregate report indicating a plurality of power measurements over multiple sensing attempts.
104. The device of one or more of clauses 85-104, where the multiple sensing attempts include one of:
multiple sensing attempts at the same transmit frequency over time; or
multiple sensing attempts, where each sensing attempt is at a different transmit frequency.
105. The device of clause 85, further including means for determining a final transmit power for sensing, where the determining the final transmit power includes:
setting a transmit power for transmitting the radar wireless signal to an initial transmit power;
transmitting a radar wireless signal one or more times at the transmit power;
attempting to sense a reflection of the radar wireless signal; and
recursively increasing the transmit power by a power ramping step based on the one or more sensing attempts failing, transmitting the radar wireless signal one or more times at an increased transmit power, and attempting to sense the reflection of the radar wireless signal until the device successfully senses the reflection of the radar wireless signal, where the increased transmit power used for the successful sensing attempt is the final transmit power for sensing.
106. The device of one or more of clauses 85-105, where the radar wireless signal is transmitted up to a maximum number of transmissions at a same transmit power before determining that the one or more sensing attempts failed at the same transmit power.
107. The device of one or more of clauses 85-106, further including:
means for generating one or more sensing HRs for the one or more failed sensing attempts; and
means for providing the one or more sensing HRs to the network entity.
108. The device of one or more of clauses 85-107, where the one or more sensing HRs for the one or more failed sensing attempts include one or more indications of:
the transmit power;
a transmission counter of a number of transmissions by the device at the same transmit power; or
a power ramping counter of a number of times the transmit power has been increased by the power ramping step.
109. The device of one or more of clauses 85-106, further including means for obtaining an indication of one or more device parameters to be configured by the device for sensing, where the one or more device parameters include one or more of:
the initial transmit power;
the power ramping step;
the maximum number of transmissions at the same transmit power; or
an overall maximum number of transmissions to be performed before the device is to determine that sensing has failed.
110. The device of clause 85, where the device is a user equipment (UE).
111. The device of one or more of clauses 85-110, where the network entity is one or more of:
a base station serving the UE; or
one or more neighboring UEs within range of the UE.
112. The device of clause 85, where the device is a base station and the network entity is a radar server.

Therefore, it is intended that claimed subject matter not be limited to the particular examples disclosed, but that such claimed subject matter may also include all aspects falling within the scope of appended claims, and equivalents thereof.

1. A method of generating a sensing headroom report (HR) by a first device in a wireless network, comprising:
transmitting a radio detection and ranging (radar) wireless signal on a wireless medium at a first transmit power from one or more transmit chains of the first device;
sensing the radar wireless signal;
generating a sensing HR based on sensing the radar wireless signal; and
providing the sensing HR to a network entity in the wireless network.

2. The method of claim 1, wherein sensing the radar wireless signal includes sensing the radar wireless signal directly from at least one of the one or more transmit chains of the first device, wherein a measured self-interference (SI) power of the sensed radar wireless signal corresponds to the radar wireless signal sensed directly from the at least one of the one or more transmit chains of the first device.

3. The method of claim 2, wherein the sensing HR includes an indication of a sensing headroom, wherein the sensing headroom is a difference between the SI power and a maximum SI power for sensing.

4. (canceled)

5. The method of claim 2, wherein sensing the radar wireless signal further includes:
sensing a reflection of the radar wireless signal on the wireless medium, wherein a measured first receive power of the reflection of the radar wireless signal corresponds to the reflection sensed on the wireless medium; and
sensing a noise on the wireless medium, wherein:
a measured noise power corresponds to the noise sensed on the wireless medium; and
the sensing HR includes an indication of one or more of:
the SI power minus the noise power;
a total received power minus the SI power minus the noise power; or
the total received power minus the noise power.

6. The method of claim 1, wherein the sensing HR includes an indication of a power headroom (PH) for sensing, wherein the PH for sensing is a difference between a maximum transmit power for sensing and a desired transmit power for sensing; an aggregate report indicating a plurality of power measurements over multiple sensing attempts; or a combination thereof.

7. (canceled)

8. The method of claim 6, wherein the desired transmit power for sensing is one of:
a transmit power for sensing determined by the first device; or
a requested transmit power, wherein an indication of the requested transmit power is obtained from one of:
a radar server of the wireless network, wherein the first device is a base station;
a base station serving the first device, wherein the first device is a user equipment (UE); or
a relay UE, wherein the first device is a UE within range of the relay UE.

9. The method of claim 1, further comprising:
obtaining a request by a radar server of the wireless network to adjust a present transmit power for sensing, wherein the adjustment is based on the sensing HR.

10. The method of claim 1, wherein providing the sensing HR to the network entity includes one of:
unicasting the sensing HR to a second device in the wireless network;
broadcasting the sensing HR to the second device;
groupcasting the sensing HR to the second device; or
sending the sensing HR to a radar server of the wireless network, wherein the first device is a base station.

11. (canceled)

12. (canceled)

13. The method of claim 1, further comprising obtaining a trigger to provide the sensing HR, wherein:
the trigger is obtained in one of:
downlink control information (DCI) on a NR-Uu interface to a base station serving the first device; or
sidelink control information (SCI) on a NR-based sidelink;
the sensing HR is provided to the network entity in response to obtaining the trigger; and
the trigger is based on a request from a radar server of the wireless network for the sensing HR from the first device.

14. (canceled)

15. The method of claim 1, further comprising obtaining an indication of one or more parameters for generating the sensing HR;
wherein:
the indication is obtained in a media access control layer control element (MAC-CE) on a NR-Uu interface to a base station serving the first device or on a NR-based sidelink; and
configuration of the one or more parameters is persisted for one or more sensing HRs until another indication of the one or more parameters is obtained.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A device in a wireless network configured for generating a sensing headroom report (HR), comprising:
at least one transceiver;
at least one memory; and
at least one processor coupled to the at least one transceiver and the at least one memory, wherein the at least one processor is configured to cause the device to:
transmit, via the at least one transceiver, a radio detection and ranging (radar) wireless signal on a wireless medium at a first transmit power from one or more transmit chains of the device;
sense, via the at least one transceiver, the radar wireless signal;
generate, via the at least one processor, the sensing HR based on sensing the radar wireless signal; and
provide, via the at least one transceiver, the sensing HR to a network entity in the wireless network.

30. The device of claim 29, wherein sensing the radar wireless signal includes sensing the radar wireless signal directly from at least one of the one or more transmit chains of the device, wherein a measured self-interference (SI) power of the sensed radar wireless signal corresponds to the radar wireless signal sensed directly from the at least one of the one or more transmit chains of the device.

31. The device of claim 30, wherein the sensing HR includes an indication of a sensing headroom, wherein the sensing headroom is a difference between the SI power and a maximum SI power for sensing.

32. (canceled)

33. The device of claim 30, wherein:
the at least one processor is configured to further cause the device to:
sense, via the at least one transceiver, a reflection of the radar wireless signal on the wireless medium, wherein a measured first received power of the reflection of the radar wireless signal corresponds to the reflection sensed on the wireless medium; and
sense, via the at least one transceiver, a noise associated with sensing the reflection, wherein:
a measured noise power corresponds to the noise sensed on the wireless medium; and
the sensing HR includes an indication of one or more of:
the SI power minus the noise power;
a total received power minus the SI power minus the noise power; or
the total received power minus the noise power.

34. The device of claim 29, wherein the sensing HR includes an indication of a power headroom (PH) for sensing, wherein the PH for sensing is a difference between a maximum transmit power for sensing and a desired transmit power for sensing; an aggregate report indicating a plurality of power measurements over multiple sensing attempts; or a combination thereof.

35. (canceled)

36. The device of claim 34, wherein the desired transmit power for sensing is one of:
a transmit power for sensing determined by the device; or
a requested transmit power, wherein an indication of the requested transmit power is obtained from one of:
a radar server of the wireless network, wherein the device is a base station;
a base station serving the device, wherein the device is a user equipment (UE); or
a relay UE, wherein the device is a UE within range of the relay UE.

37. The device of claim 29, wherein the at least one processor is configured to further cause the device to obtain, via the at least one transceiver, a request by a radar server of the wireless network to adjust a present transmit power for sensing, wherein the adjustment is based on the sensing HR.

38. The device of claim 29, wherein providing the sensing HR to the network entity includes one of:
unicasting the sensing HR to a second device in the wireless network;
broadcasting the sensing HR to the second device;
groupcasting the sensing HR to the second device; or
sending the sensing HR to a radar server of the wireless network, wherein the device is a base station.

39. (canceled)

40. (canceled)

41. The device of claim 29, wherein the at least one processor is configured to further cause the device to obtain, via the at least one transceiver, a trigger to provide the sensing HR, wherein:
the trigger is obtained in one of:
downlink control information (DCI) on a NR-Uu interface to a base station serving the device; or
sidelink control information (SCI) on a NR-based sidelink;
the sensing HR is provided to the network entity in response to obtaining the trigger; and
the trigger is based on a request from a radar server of the wireless network for the sensing HR from the device.

42. (canceled)

43. The device of claim 29, wherein the at least one processor is configured to further cause the device to obtain, via the at least one transceiver, an indication of one or more parameters for generating the sensing HR;
wherein:
the indication is obtained in a media access control layer control element (MAC-CE) on a NR-Uu interface to a base station serving the device or on a NR-based sidelink; and
configuration of the one or more parameters is persisted for one or more sensing HRs until another indication of the one or more parameters is obtained.

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. A non-transitory computer-readable medium storing instructions that, when executed by at least one processor of a device in a wireless network configured for generating a sensing headroom report (HR), causes the device to:
transmit, via at least one transceiver of the device, a radio detection and ranging (radar) wireless signal on a wireless medium at a first transmit power from one or more transmit chains of the device;
sense, via the at least one transceiver, the radar wireless signal;
generate, via the at least one processor, the sensing HR based on sensing the radar wireless signal; and
provide, via the at least one transceiver, the sensing HR to a network entity in the wireless network.

58. The computer-readable medium of claim 57, wherein sensing the radar wireless signal includes sensing the radar wireless signal directly from at least one of the one or more transmit chains of the first device, wherein a measured self-interference (SI) power of the sensed radar wireless signal corresponds to the radar wireless signal sensed directly from the at least one of the one or more transmit chains of the first device.

59. The computer-readable medium of claim 58, wherein the sensing HR includes an indication of a sensing headroom, wherein the sensing headroom is a difference between the SI power and a maximum SI power for sensing.

60. (canceled)

61. The computer-readable medium of claim 58, wherein: execution of the instructions further causes the device to:
sense, via the at least one transceiver, a reflection of the radar wireless signal on the wireless medium, wherein a measured first received power of the reflection of the radar wireless signal corresponds to the reflection sensed on the wireless medium; and
sense, via the at least one transceiver, a noise associated with sensing the reflection, wherein:
a measured noise power corresponds to the noise sensed on the wireless medium; and
the sensing HR includes an indication of one or more of:
the SI power minus the noise power;
a total received power minus the SI power minus the noise power; or
the total received power minus the noise power.

62. The computer-readable medium of claim 57, wherein the sensing HR includes an indication of a power headroom (PH) for sensing, wherein the PH for sensing is a difference between a maximum transmit power for sensing and a desired transmit power for sensing; an aggregate report indicating a plurality of power measurements over multiple sensing attempts; or a combination thereof.

63. (canceled)

64. The computer-readable medium of claim 62, wherein the desired transmit power for sensing is one of:
a transmit power for sensing determined by the device; or
a requested transmit power, wherein an indication of the requested transmit power is obtained from one of:
a radar server of the wireless network, wherein the device is a base station;
a base station serving the device, wherein the device is a user equipment (UE); or
a relay UE, wherein the device is a UE within range of the relay UE.

65. The computer-readable medium of claim 57, wherein execution of the instructions further causes the device to obtain, via the at least one transceiver, a request by a radar server of the wireless network to adjust a present transmit power for sensing, wherein the adjustment is based on the sensing HR.

66. The computer-readable medium of claim 57, wherein providing the sensing HR to the network entity includes one of:
unicasting the sensing HR to a second device in the wireless network;
broadcasting the sensing HR to the second device;
groupcasting the sensing HR to the second device; or
sending the sensing HR to a radar server of the wireless network, wherein the device is a base station.

67. (canceled)

68. (canceled)

69. The computer-readable medium of claim 57, wherein execution of the instructions further causes the device to obtain, via the at least one transceiver, a trigger to provide the sensing HR, wherein:
the trigger is obtained in one of:
downlink control information (DCI) on a NR-Uu interface to a base station serving the device; or
sidelink control information (SCI) on a NR-based sidelink;
the sensing HR is provided to the network entity in response to obtaining the trigger; and
the trigger is based on a request from a radar server of the wireless network for the sensing HR from the device.

70. (canceled)

71. The computer-readable medium of claim 57, wherein execution of the instructions further causes the device to obtain, via the at least one transceiver, an indication of one or more parameters for generating the sensing HR;
wherein:
the indication is obtained in a media access control layer control element (MAC-CE) on a NR-Uu interface to a base station serving the device or on a NR-based sidelink; and
configuration of the one or more parameters is persisted for one or more sensing HRs until another indication of the one or more parameters is obtained.

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. A device for generating a sensing headroom report (HR) in a wireless network, comprising:
means for transmitting a radio detection and ranging (radar) wireless signal on a wireless medium at a first transmit power from one or more transmit chains;
means for sensing the radar wireless signal;
means for generating a sensing HR based on sensing the radar wireless signal; and
means for providing the sensing HR to a network entity in the wireless network.

86. The device of claim 85, wherein the means for sensing the radar wireless signal includes means for sensing the radar wireless signal directly from at least one of the one or more transmit chains, wherein a measured self-interference (SI) power of the sensed radar wireless signal corresponds to the radar wireless signal sensed directly from the at least one of the one or more transmit chains.

87. The device of claim 86, wherein the sensing HR includes an indication of a sensing headroom, wherein the sensing headroom is a difference between the SI power and a maximum SI power for sensing.

88. (canceled)

89. The device of claim 86, wherein the means for sensing the radar wireless signal further includes:
means for sensing a reflection of the radar wireless signal on the wireless medium, wherein a measured first received power of the reflection of the radar wireless signal corresponds to the reflection sensed on the wireless medium; and
means for sensing a noise on the wireless medium, wherein:
a measured noise power corresponds to the noise sensed on the wireless medium; and
the sensing HR includes an indication of one or more of:
the SI power minus the noise power;
a total received power minus the SI power minus the noise power; or
the total received power minus the noise power.

90. The device of claim 85, wherein the sensing HR includes an indication of a power headroom (PH) for sensing, wherein the PH for sensing is a difference between a maximum transmit power for sensing and a desired transmit power for sensing; an aggregate report indicating a plurality of power measurements over multiple sensing attempts; or a combination thereof.

91. (canceled)

92. The device of claim 90, wherein the desired transmit power for sensing is one of:
a transmit power for sensing determined by the device; or
a requested transmit power, wherein an indication of the requested transmit power is obtained from one of:
a radar server of the wireless network, wherein the device is a base station;
a base station serving the device, wherein the device is a user equipment (UE); or
a relay UE, wherein the device is a UE within range of the relay UE.

93. The device of claim 85, further comprising:
means for obtaining a request by a radar server of the wireless network to adjust a present transmit power for sensing, wherein the adjustment is based on the sensing HR.

94. The device of claim 85, wherein the means for providing the sensing HR to the network entity includes one of:
means for unicasting the sensing HR to a second device in the wireless network;
means for broadcasting the sensing HR to the second device;
means for groupcasting the sensing HR to the second device; or
means for sending the sensing HR to a radar server of the wireless network, wherein the device is a base station.

95. (canceled)

96. (canceled)

97. The device of claim 85, further comprising means for obtaining a trigger to provide the sensing HR, wherein:
the trigger is obtained in one of:
downlink control information (DCI) on a NR-Uu interface to a base station serving the device; or
sidelink control information (SCI) on a NR-based sidelink;
the sensing HR is provided to the network entity in response to obtaining the trigger; and
the trigger is based on a request from a radar server of the wireless network for the sensing HR from the device.

98. (canceled)

99. The device of claim 85, further comprising means for obtaining an indication of one or more parameters for generating the sensing HR;
wherein:
the indication is obtained in a media access control layer control element (MAC-CE) on a NR-Uu interface to a base station serving the device or on a NR-based sidelink; and
configuration of the one or more parameters is persisted for one or more sensing HRs until another indication of the one or more parameters is obtained.

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)
